(19) United States
(12) Patent Application Publication
(10) Pub. No.: US 2025/0355780 A1
(43) Pub. Date: Nov. 20, 2025

(54) LARGE SCALE EVENT FAULT SIMULATOR

(71) Applicant: Oracle International Corporation, Redwood Shores, CA (US)

(72) Inventors: Art Paul Plata, Kenmore, WA (US); Pavani Haridasyam, Redmond, WA (US); Zeke Kaufman, Cambridge, MA (US); Sunil Soman, Seattle, WA (US); Min Ni, Bothell, WA (US); Shouyi Zhang, Seattle, WA (US); Ashley Valent, Seattle, WA (US); Jinzhu Deng, Seattle, WA (US)

(73) Assignee: Oracle International Corporation, Redwood Shores, CA (US)

(21) Appl. No.: 18/664,400

(22) Filed: May 15, 2024

(51) Int. Cl. G06F 11/34; G06F 9/455

(52) U.S. Cl. CPC G06F 11/3457; G06F 9/45558; G06F 2009/45591

(57) ABSTRACT

Techniques discussed herein relate to enabling a hypervisor to self-recover. In particular, a watchdog daemon may be executed at the hypervisor to perform periodic write disk checks of the boot volume associated with the hypervisor. Suppose an attempt to write to disk fails (e.g., an Error Input/Output (EIO) or Error Read Only File System (EROFS) return code is received. In that case, the daemon may determine that the boot volume is in read-only mode, post metrics to one or more logging services to indicate that the daemon has detected a read-only boot volume and reboot the respective hypervisor.

### BACKGROUND

Virtualization has become common place in multi-tenant clouds. By running multiple virtual machines (VMs) atop a hypervisor, the efficiency of a server machine can be maximized. During large-scale events (LSEs), a widespread outage is experienced. During an LSE, the data plane is typically impacted due to either power going down, from loss of a critical dependency (e.g., an identity management service, a block storage data plane, etc.) that can go offline, or by hosts getting disconnected from the network. Recovery systems for LSEs are crucial for maintaining business continuity and minimizing downtime. Conventionally, data plane resource recovery can take 10 minutes, 25 minutes, or longer when human intervention is not required. If human intervention is required, recovery can take hours, greatly impacting customers.

Models may be used to predict the behavior of data center networks under various conditions, including failure scenarios. The output of these models may be used to plan, operate, and maintain data center networks. They may aid engineers to anticipate and LSE. Most LSE models suffer from a lack of realism. Moreover, the accuracy of the model may be questionable.

### BRIEF SUMMARY

Techniques are provided to simulate LSE faults on a controlled set of computing components (e.g., host machines, hypervisors, or smart network interface cards (NICs)). The simulation collects data to allow auditing and analyzing the recovery process and implement improvements such as automating the recovery processes and optimizing execution. To audit the recovery system, the simulator may be deployed and used to simulate a fault and collect data throughout the recovery process. The simulation tool may launch and configure physical servers (e.g., bare metals, install hypervisors on the servers) and efficiently allocate virtual machines (VMs) to physical servers (e.g., densely pack the hypervisors). Once the instances are stable and running, the simulator may simulate an LSE fault (e.g., a power outage or block storage fault). The simulation may allow enough time for the fault to propagate through the network and for all the targeted computing components to be impacted by the LSE. The simulator may simulate the removal of the root cause of the fault. For example, the simulator may power on the impacted computing components when simulating a power outage. The system recovery process may start restoring the system, and the simulator collects data associated with the recovery process. The timestamp results of all recovery timelines may be stored and analyzed.

At least one embodiment is directed to a method for monitoring and transmitting recovery metrics associated with the recovery of a set of hypervisors from an LSE (e.g., a power outage). The method may comprise identifying a set of one or more hypervisors for outage simulation, wherein a set of one or more computing devices respectively host the set of hypervisors. The method may further comprise identifying a set of one or more integrated managers respectively corresponding to the set of computing devices hosting the set of hypervisors. In some embodiments, the method may further comprise simulating an outage based at least in part on executing, by each of the set of integrated managers, a first set of one or more operations associated with powering down the set of computing devices. In some embodiments, the method may further comprise simulating a restoration based at least in part on executing, by each of the set of integrated managers, a second set of one or more operations associated with powering up the set of computing devices. The method may further comprise monitoring and transmitting recovery metrics associated with the recovery of the set of hypervisors. In some embodiments, the metrics are monitored and/or transmitted in response to stimulating the restoration.

In some embodiments, the set of integrated managers may individually comprise a set of processors. Each set of processors may be embedded in the set of computing devices, and the set of processors may be configured to provide management interfaces for the set of computing devices.

In some embodiments, the firmware on the set of processors may be configured to operate in response to applying power to the set of computing devices, regardless of whether the set of computing devices has been powered on.

In some embodiments, executing the first set of one or more operations associated with powering down the set of computing devices may cause shutdowns of the set of computing devices that close at least one of the applications or files opened on the set of computing devices without saving changes.

In some embodiments, the method may further perform at least one of: presenting at least one of the recovery metrics at a user interface and transmitting information indicating a result of a comparison between at least a recovery metric of the recovery metrics and at least one of a predefined threshold or a historically derived value for the recovery metric.

In some embodiments, the recovery of the set of hypervisors is determined based on confirming that connections to the set of computing devices have been established subsequent to stimulating the restoration.

In some embodiments, simulating the outage may comprise transmitting a first set of one or more instructions to the set of integrated managers to power down the set of computing devices. In some embodiments, simulating the restoration comprises transmitting a second set of one or more instructions to a set of integrated managers to power up the set of computing devices.

In some embodiments, monitoring the recovery metrics may comprise 1) periodically attempting to establish connections to the set of computing devices and 2) measuring a duration between (a) a first time associated with simulating the restoration and (b) a second time associated with successfully establishing the connections to the set of computing devices.

In some embodiments, the set of one or more hypervisors may be selected from a plurality of hypervisors for the outage simulation based at least in part on a command provided as input to a command line interface. In some embodiments, the command may reference a configuration file that identifies the set of one or more hypervisors.

At least one embodiment is directed to a method for monitoring and transmitting recovery metrics associated with the recovery of a set of hypervisors from a fault (e.g., a block storage fault such as a boot volume going down or otherwise becoming unavailable). The method may comprise identifying a set of one or more hypervisors for fault simulation, wherein a set of one or more computing devices respectively host the set of one or more hypervisors, and the set of hypervisors is associated with a set of boot volumes (e.g., each hypervisor being associated with a corresponding boot volume). The method may further comprise identifying a set of one or more network interface cards respectively corresponding to the set of computing devices hosting the set of hypervisors. In some embodiments, the method may further comprise simulating a fault based at least in part on executing, by each of the set of network interface cards, a first set of one or more operations associated with detaching the set of boot volumes respectively from the set of hypervisors. In some embodiments, the method may further comprise simulating a restoration based at least in part on executing, by each of the network interface cards, a second set of one or more operations associated with re-attaching the set of boot volumes respectively to the set of hypervisors. The method may perform monitoring and transmitting recovery metrics, respectively, associated with the recovery of the set of hypervisors responsive to stimulating the restoration.

In some embodiments, the set of network interface cards respectively may comprise a set of processors. The set of processors may be embedded in the set of network interface cards (e.g., with one or more processors of the set being embedded in a given network interface card), and the set of processors may be configured to provide management interfaces respectively for the set of network interface cards.

In some embodiments, executing the first set of operations associated with detaching the set of boot volumes respectively from the set of hypervisors may cause a corresponding set of integrated managers of the set of computing devices to power down the set of computing devices. Powering down the set of computing devices may close at least one of the applications or files, respectively opened on the set of computing devices, without saving changes.

In some embodiments, the set of integrated managers may comprise a set of processors. The set of processors may be embedded in the set of integrated managers (e.g., with one or more processors of the set being embedded in a given integrated manager). The set of processors may be configured to provide management interfaces respectively for the set of computing devices, and firmware on the set of processors may respectively be configured to operate in response to applying power to the set of computing devices, regardless of whether the set of computing devices have been powered on.

In some embodiments, the method may further comprise initializing one or more validation processes configured to periodically attempt to establish connections to the computing devices. One or more validation processes may be initialized based at least in part on detecting that respective connections to the network interface cards have been established.

In some embodiments, executing the first set of operations associated with detaching the set of boot volumes respectively from the set of hypervisors may cause respective watchdog daemons executing at each of the set of computing devices to: transmit one or more write requests to a corresponding boot volume; detect, based on the one or more write requests, that the corresponding boot volume is in a read-only mode; and initiate a reboot of a corresponding hypervisor, causing the corresponding hypervisor to enter a wait-for-recovery mode to wait for recovery of a boot volume dependency.

In some embodiments, a simulation system is disclosed. The simulation system may comprise one or more processors and one or more memories storing computer-executable instructions that, when executed by one or more processors, cause one or more processors to perform operations. The operations may include identifying a set of one or more hypervisors, wherein a set of one or more computing devices respectively host the set of hypervisors. The operations may further include identifying a set of one or more computing components respectively corresponding to the set of computing devices hosting the set of hypervisors. In some embodiments, the operations may comprise simulating a large-scale event based at least in part on executing, by each of the set of computing components, a first set of one or more operations. In some embodiments, the operation may comprise simulating a restoration based at least in part on executing, by each of the set of computing components, a second set of one or more operations. In some embodiments, the operations may comprise monitoring and transmitting recovery metrics, respectively, associated with the recovery of the set of hypervisors responsive to stimulating the restoration.

In some embodiments, the large-scale event may be a power outage or a block storage outage.

In some embodiments, executing the computer-executable instructions may further cause one or more processors to perform at least one of: generating one or more graphical representations depicting aspects of the recovery of the set of hypervisors or corresponding to a set of virtual machines respectively managed by the set of hypervisors; and transmitting at least one of the recovery metrics to one or more logging services.

In some embodiments, the set of computing components may comprise an integrated manager when the large-scale event is associated with a first event type. The set of computing components may comprise network interface cards when the large-scale event is associated with a second event type.

In some embodiments, the first set of operations may be associated with powering down a corresponding computing device when the large-scale event is associated with a first event type. In some embodiments, the first set of operations may be associated with detaching a network connection when the large-scale event is associated with a second event type.

### BRIEF DESCRIPTION OF THE DRAWINGS

FIG. 1 illustrates a block diagram illustrating a cloud computing environment for implementing the present disclosure, according to at least one embodiment.

FIG. 2 illustrates an example of a launch configuration according to at least one embodiment.

FIG. 3 illustrates a block diagram that depicts an example simulation system that is configured to simulate an outage according to at least one embodiment.

FIG. 4 is a block diagram illustrating an example method for simulating an outage in accordance with at least one embodiment.

FIG. 5 illustrates a block diagram depicting an example simulation system that is configured to simulate a block storage fault according to at least one embodiment.

FIG. 6 is a block diagram illustrating an example method for simulating a block storage fault in accordance with at least one embodiment.

FIG. 7 is a block diagram illustrating an example method utilizing a watchdog daemon for detecting and recovering from hypervisor unresponsiveness, according to at least one embodiment.

FIG. 8 is a block diagram depicting an example graphical interface of a logging service, according to at least one embodiment.

FIG. 9 is a block diagram depicting an example graphical interface of a simulation service, according to at least one embodiment.

FIG. 10 is a block diagram depicting an example graphical interface of another simulation service, according to at least one embodiment.

FIG. 11 is a block diagram illustrating an example method for simulating an outage in accordance with at least one embodiment.

FIG. 12 is a block diagram illustrating an example method for simulating a fault in accordance with at least one embodiment.

FIG. 13 is a block diagram illustrating one pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating another pattern for implementing a cloud infrastructure as a service system, according to at least one embodiment.

FIG. 16 is a block diagram illustrating another pattern for implementing a cloud infrastructure as a service system, according to at least one embodiment.

FIG. 17 is a block diagram illustrating an example computer system according to at least one embodiment.

### DETAILED DESCRIPTION

In the following description, various embodiments will be described. For purposes of explanation, specific configurations, and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

### INTRODUCTION

A fault in a cloud computing system may refer to a situation where a critical component or service on which other components, services, or systems depend fails or becomes unavailable. The fault may include hardware components, software services, network connections, or external providers. A fault may disrupt the normal functioning of the entire system, leading to potential service interruptions, data loss, or degraded performance.

During an LSE, the compute data plane is typically impacted due to power going down, a critical dependency (e.g., identity, block storage data plane) going offline, or hosts getting disconnected from the network. The end users often care about how long it takes to recover from an LSE to minimize business impact. The compute data plane is often the underlying infrastructure for higher-level services; thus, it is critical that compute data plane recovery happens quickly.

In some instances, compute data plane recovery may take 10 to 25 minutes when human intervention is not required. If human intervention is required, as is often the case, the process may take hours, delaying recovery for the end users. It is desirable to reduce the number and time of manual interventions.

In some instances, a fault may be a power outage or, in short, an outage. An LSE power outage may refer to a situation where the primary power source fails, causing an interruption in the operation of the data center. Power outages may occur for various reasons, such as grid instability, extreme weather, failing cooling systems, or infrastructure aging. The downtime caused by a power outage may lead to data loss, operations disruptions, or financial losses. It is desired to predict and prevent power outages; when they happen, it is desired to minimize downtime. Embodiments described herein address these and other problems, individually and collectively.

In some instances, a fault may be a block storage outage. A block storage outage may cause the hypervisor's boot volume to become read-only. While the hypervisor's boot volume is read-only, the hypervisor may not be able to self-recover. Block storage outages that trigger read-only boot volumes may cause system unavailability, data integrity risks, and the inability to apply updates or patches or perform diagnostics or troubleshooting. Conventionally, restoring write access to the boot volume required a manual reboot of the hypervisor. However, manual reboots may cause excessive delay with respect to returning the system to a fully operational state. Embodiments described herein address these and other problems, individually and collectively.

The disclosed techniques utilize a benchmarking tool to produce LSEs in a distributed (e.g., cloud, infrastructure region). The benchmarking tool can measure the recovery of compute instances. The benchmark tool will cover scenarios with a critical dependency failure, including power (time to recover from power loss event), network isolation, and key dependencies like block storage failing. The benchmarking tool may allow for consistently improving recovery performance through iterations of testing and resolving problems.

The disclosed techniques may also utilize a computer process (e.g., a watchdog daemon) to monitor the hypervisor's boot volume to enable hypervisors to recover from outages that caused the boot volume to transition to a read-only mode. The watchdog daemon may initiate a reboot of the hypervisor based on detecting that the boot volume has transitioned to read-only mode. Following the reboot initiation, the hypervisor may enter a “wait-for-recovery” mode. For example, the “wait-for-recovery” mode may be implemented by an enhanced pre-boot execution environment (PXE) boot loop to wait for dependency recovery. A watchdog daemon may be deployed with each hypervisor (e.g., as part of the hypervisor's image) to locally identify situations in which a corresponding hypervisor loses write access to its boot volume (e.g., a boot volume provided via block storage and accessible via one or more networks).

Some legacy solutions were not configured to detect particular errors (e.g., EIO, EROFS, etc.), which caused read-only boot volumes to be missed. During an outage (e.g., a Large Scale Event that affects a large number of computing components), logging may not be available because files were needed from the boot volume, which was not available due to the outage. To address some of these deficiencies, data assets may be stored in the local memory of the host machine (e.g., local memory such as hard drive space assigned to a hypervisor operating at the host machine) to enable the watchdog daemon to perform logging and to reduce the typical dependencies usually needed for logging data in the system. A watchdog daemon may also be configured to print console messages to a baseboard management controller in order to persist the data after hypervisor reboot when such data would otherwise be lost in most legacy solution implementations. The data that was logged and/or persisted locally at the host device may include any suitable data related to detecting the read-only state of a boot volume. In some embodiments, the resource consumption of the watchdog daemon is limited to keep the daemon from exhausting system resources.

### Architecture

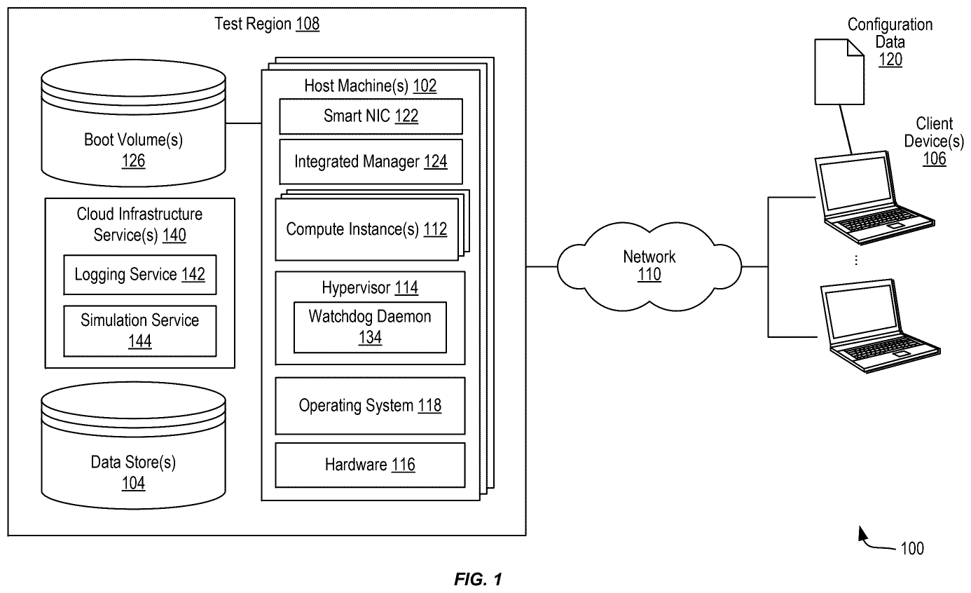

FIG. 1 illustrates a block diagram illustrating a cloud computing environment 100 for implementing the present disclosure, according to at least one embodiment. In some embodiments, the cloud computing environment 100 includes any suitable number of one or more host machines (e.g., host machine(s) 102) and one or more data store(s) 104 for providing to one or more client device(s) 106 access to cloud service provider infrastructure (CSPI) (e.g., CSPI 108) via a public network (e.g., network 110, the Internet). The CSPI 108 may be an Infrastructure-as-a-Service (IaaS) platform having a combination of hardware and software configured to carry out aspects of the present disclosure. Each of the host machine(s) 102 may execute one or more virtualized components. By way of example, each of the host machine(s) 102 may correspond to a physical device on which various compute instances (e.g., compute instance(s) 112) may be hosted. Compute instance(s) 112 is intended to be an example of virtual machine instances, referred to herein as “VMs.”

One or more of the host machine(s) 102 may execute a hypervisor (e.g., hypervisor 114) that creates and manages a virtualized environment. A hypervisor (e.g., hypervisor 114) may be run on a single physical server's hardware (e.g., hardware 116) that is configured to run operating system 118. Hypervisor 114 may be configured to create and manage any suitable number of compute instance(s) 112. Each of the compute instance(s) 112 may be an example of a virtual machine. A “virtual machine” refers to a compute resource that is a virtualization or emulation of a physical computer system. Compute instance(s) 112 may be run on a single physical server's hardware (e.g., hardware 116) that is configured to run operating system 118. The hypervisor 114 may be configured to ensure that each virtual machine (VM) (e.g., compute instance(s) 112) is isolated from all other VMs and that each VM is configured with its own operating system and kernel (e.g., guest operating system). The hypervisor 114 may enable the physical computing resources of a host machine (e.g., hardware 116, including compute, memory, and networking resources) to be shared between the compute instance(s) 112 executed by the host machine.

Utilizing virtual machines (e.g., compute instance(s) 112) enables applications to be isolated between VMs and provides a level of security as the information of one application cannot be freely accessed by another application. Each compute instance(s) 112 may be a full machine running all the components needed (e.g., applications and bins/libraries, etc.), including its own operating system (e.g., guest operating system), on top of the virtualized hardware. Each compute instance running on hypervisor 114 provides logical isolation in which no compute instance shares memory space with or awareness of other compute instances of the host machine.

Host machine(s) 102 may include a smart NIC 122. Smart NIC 122 may include components of a computer system such as one or more central processing or graphical processing units (CPUs or GPUs), memory, and highspeed input/output (I/O) interfaces. Smart NIC 122 may be communicatively coupled with VMs or components of host machine(s) 102. Smart NIC 122 may provide network connectivity to the host machine(s) 102 to allow offloading networking, security, storage, and other overhead operations from the server CPU. In particular, smart NIC 122 may provide connectivity to the boot volume(s) 126.

In some embodiments, the hypervisor 114 and its associated boot volume(s) 126 may be connected through a small computer system interface (SCSI) or Internet-based SCSI (iSCSI). The SCSI or iSCSI may include a set of standard protocols used for physically connecting and transferring data between components of the CSPI 108.

The hypervisor 114 may be deployed with or subsequently configured with a SCSI device (SCSI-D) daemon. SCSI-D daemon may be an example compute agent or process that executes at a host machine and is configured to monitor and manage SCSI or iSCSI connection between hypervisor 114 and its associated boot volume(s) 126.

In some embodiments, a boot volume may be encrypted by default. The boot volume(s) 126 may be remote with respect to the host machine(s) 102 and accessible via one or more networks (not depicted) of CSPI 108. When a compute instance is launched using an image, a boot volume for the compute instance may be created and added to boot volume(s) 126. The boot volume may be associated with the compute instance until the instance is terminated. When the compute instance is terminated, the boot volume and its data may be preserved. In some cases, a boot volume may be used to launch a new compute instance.

The hypervisor 114 may be deployed with or subsequently configured with watchdog daemon 134. Watchdog daemon 134 may be an example compute agent or process that executes at a host machine and is configured to perform periodic write disk checks to a boot volume with which the hypervisor 114 is associated (e.g., one of boot volume(s) 126). A “boot volume” refers to a storage container (e.g., a block volume, a detachable boot volume device, etc.) that may contain the image used to boot a resource (e.g., a hypervisor, each of compute instance(s) 112, etc.).

Watchdog daemon 134 may be a Linux system-managed service. In some instances, each hypervisor may be isolated and may have a watchdog daemon running on it. In some embodiments, the watchdog daemon 134 may be installed at the host machine(s) 102, separate from the hypervisor 114. Watchdog daemon 134 may perform local operations at the host machine(s) 102 based on detecting a read-only boot volume associated with the local hypervisor.

In some embodiments, watchdog daemon 134 may be deployed as part of the hypervisor. The network dependencies may impact conventional centralized implementations due to their utilization of network-based boot volume health monitoring. The disclosed techniques that include locally executing watchdog daemon 134 at the host machine(s) 102 may alleviate the system from such network dependencies, making the detection and remedy of read-only boot volumes more reliable.

Watchdog daemon 134 may include or otherwise be communicatively connected to one or more logging service(s) 142. Logging service(s) 142 may be provided by cloud infrastructure service(s) 140. Watchdog daemon 134 may transmit logging data to one or more logging service(s) 142. This data may include data associated with hypervisor 114 and/or data corresponding to an event associated with hypervisor 114. Detecting an event that is associated with a hypervisor may include detecting that a boot volume (e.g., one of boot volume(s) 126) that is associated with hypervisor 114 is in read-only mode and/or an attempt has been made to reboot boot volume(s) 126 associated with the hypervisor (e.g., the hypervisor 114 is executing a boot loop). 114. The logging data may include any suitable combination of an error type, a time, a description, diagnostics associated with a detected error, or the like.

In some embodiments, the host machine(s) 102 may include an integrated manager 124 (e.g., a Baseboard Management Controller (BMC), an Integrated Lights-Out Manager (ILOM), etc.). Integrated manager 124 may monitor system status, handle system errors, retrieve hardware inventory information, or track user activity. In some embodiments, watchdog daemon 134 may print one or more console messages, and the integrated manager 124 may store the console message (e.g., as BMC and/or ILOM data). The integrated manager 124 may store/persist console messages locally on the device hosting the hypervisor. In one example, the console message may be associated with an event (e.g., detecting that the boot volume(s) 126 associated with hypervisor 114 is read-only).

In some embodiments, the cloud computing environment 100 may include or otherwise be communicatively attached to one or more data stores (e.g., data store(s) 104, block storage, object storage, etc.) that may include any suitable combination of computing devices configured to store and organize a collection of data. In some embodiments, the data store(s) 104) may store images (and data related thereto) that have been registered for use within the cloud-computing environment 100.

An image may be an example template of a hard drive and may be used to install the operating system and other software for a compute instance. Users can create compute instances as needed to meet their compute and application requirements and the hardware's infrastructure configurations (or shapes) running the images, for example, on the host machine(s) 102. After an instance is created, the user can access the compute instance securely from their client device(s) 106, restart it, attach and detach volumes, and terminate it when done with it.

Cloud infrastructure services(s) 140 may include a simulation service 144. Simulation service 144 may run a simulation system (e.g., the LSE simulation or benchmarking tool) that can trigger LSEs and perform auditing, monitoring, and measuring recovery processes. Simulation service 144 may run test scenarios for LSE faults (e.g., power outage and block storage outage).

In some instances, simulation service 144 may receive configuration data 120. Configuration data 120 may include test scenarios or configurations such as shape, density (number of central processing units (CPUs), or size of memory), number of attachments (e.g., block storage or secondary virtual NICs), or network type (e.g., virtual function input/output (VFIO)).

Simulation service 144 may use integrated manager 124 to launch compute instance(s) 112, including launching one or more host machines (e.g., host machine(s) 102), installing hypervisor (e.g., hypervisor 114), and densely pack the hypervisor with compute instances (e.g., compute instance(s) 112). Simulation service 144 may include a benchmarking tool that may determine and select a subset of host machines, hypervisors, or compute instances to be impacted by the simulated LSE. In some embodiments, the configuration file 120 may determine the subset of instances. Simulation service 144 may utilize integrated manager 124 to simulate a fault event to the selected instances. After ensuring that all the selected instances are impacted by simulated LSE, the simulation service 144 (e.g., including an LSE simulator and/or benchmarking tool) may initiate a recovery procedure via integrated manager 124. During the recovery, the simulation service 144 (e.g., the LSE simulator and/or benchmarking tool, may measure recovery for each instance and report the results of all recoveries (e.g., via the logging service 142).

In some instances, the simulation service 144 (e.g., the LSE simulator and/or benchmarking tool) may target the hypervisors to simulate an LSE. For example, simulation service 144 may cause the integrated manager of the host machine associated with a hypervisor to power off the host machine to simulate a power outage event. In another example, to simulate a block storage outage event, simulation service 144 may disconnect the boot volume of the hypervisor.

In some embodiments, the simulation system (e.g., the LSE simulator and/or benchmarking tool) may perform a set of operations. First, the simulation system may create and pack hypervisors. Second, the simulation system may execute the LSE fault. Third, the simulation system may initiate recovery. Fourth, the simulation system may monitor and measure recovery. These operations may be performed in any suitable order.

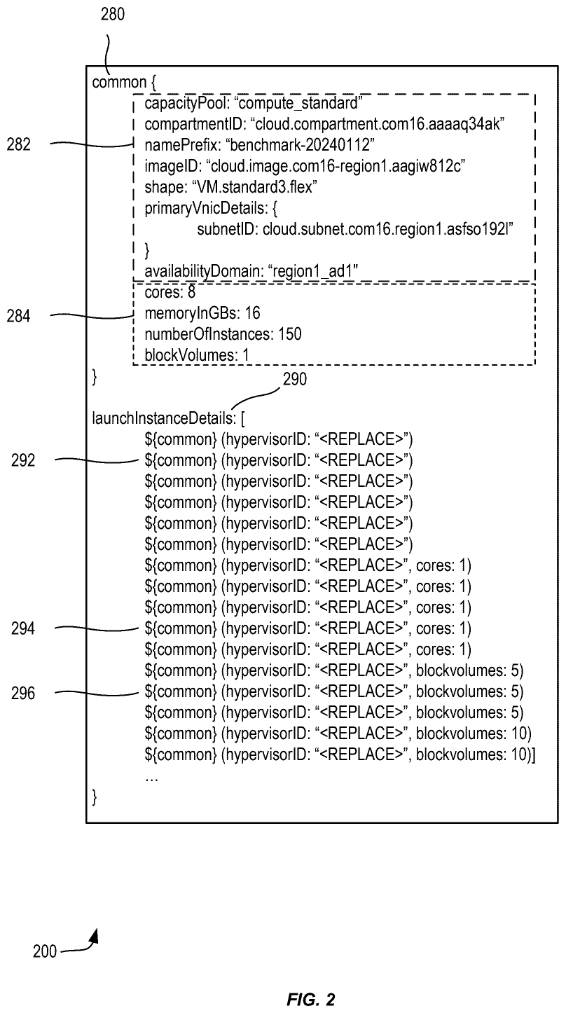

In at least one embodiment, the simulation service 144 may create and configure the hypervisors. The simulation service 144 may execute one or more commands to create and/or configure the hypervisors. The command may receive a hypervisor configuration file as input. The configuration file may include parameters to configure each hypervisor the simulation system creates. FIG. 2 is an example of a configuration file that may be used to configure a set of hypervisors.

FIG. 2 illustrates an example of a launch configuration 200 according to at least one embodiment. Launch configuration 200 is an example of configuration data 120 in FIG. 1. Launch configuration 200 may be used to launch and configure hypervisors.

In some embodiments, launch configuration 200 may include metadata including, but not limited to, common configuration data 280 and launch instance details 290. Common configuration data 280 may describe a default configuration, and launch instance details 290 may indicate whether a hypervisor is launched with the default configuration or with modifications.

Common configuration data 280 may include information identifying the physical resources (e.g., information 282) and/or parameters associated with allocated resources (e.g., information 284). For example, information 282 may include information related to the capacity pool, compartment identifier (ID), name prefix, image ID, the bare metal shape configuration, virtual NIC details, and availability domain. Information 284 may indicate/specify various attributes including, but not limited to, the size of resources allocated to the hypervisor (e.g., a number of cores), a size of memory (e.g., in gigabytes (GB)), a number of instances (e.g., virtual machines), and block storage information (e.g., a number of block volumes). In the illustrated example, the default number of cores is set to 8, the default allocated memory is set to 16 GB, the default number of instances is set to 150 virtual machines, and the default block storage volume is set to 1.

In some embodiments, parameter set 292 may be utilized to create a hypervisor using the common configuration 280. The default configurations may be overridden. For example, parameter set 294 may be utilized to create a hypervisor based on the common configuration data 280 and replace the core configuration to have one core instead of the default 8 cores. Similarly, parameter set 296 may create and configure a hypervisor based on the common configuration 280 with the block storage volume number set to 5 instead of 1, as specified in the common configuration 280. Any suitable parameter/parameter value specified in launch instance details 290 may be used to overwrite a parameter value of a corresponding parameter of common configuration 280.

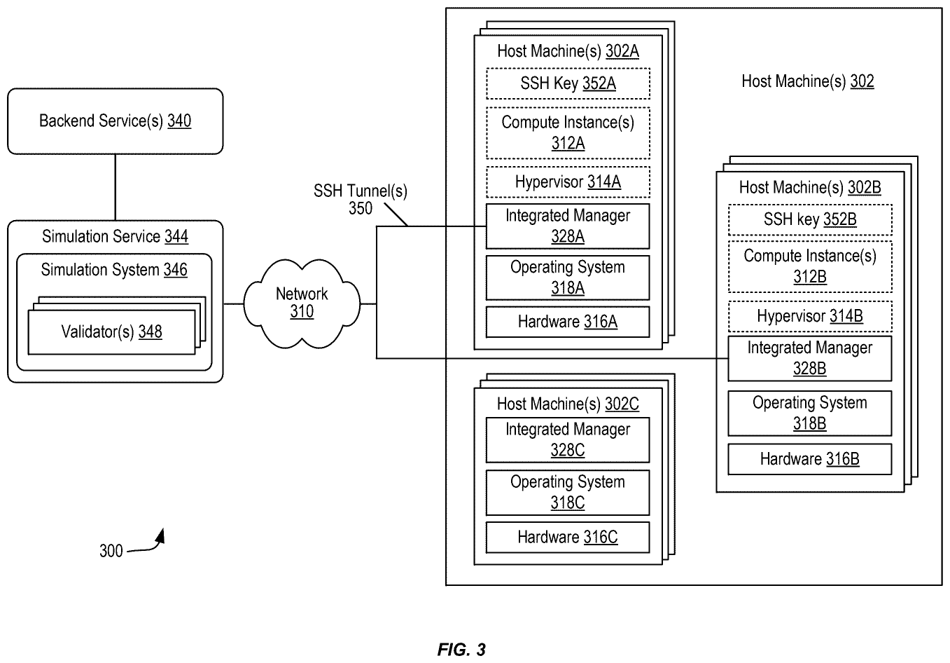

FIG. 3 illustrates a block diagram 300 depicts an example simulation that is configured to simulate a power outage LSE, according to at least one embodiment. Block diagram 300 depicts an example of a system and method for simulating a power outage by powering off and then powering on the host machines.

Simulation system 346 may be executed by simulation service 344. Simulation service 344 may be an example of simulation service 144 of FIG. 1. Simulation system 346 may provision and/or configure host machine(s) 302 (e.g., 302A, 302B, or 302C, collectively referred to herein as “host machine(s) 302,” each of which may be an example of host machine(s) 102 of FIG. 1) with one or more configurations. For example, simulation system 346 may utilize launch configuration 200 to provision/configure host machines with different parameters for hypervisors (e.g., hypervisors 314A, 314B, or 314C may differ in shape or size from one another). Alternatively, or additionally, different configurations may have different compute instances (e.g., compute instance(s) 312A, 312B, or 312C may be differently configured). Operating system 318 and hardware 316 may be examples of operating system 118 and hardware 116 of FIG. 1, respectively.

In some examples, simulation system 346 may simulate an LSE on an existing and configured host machine. For example, any suitable number of host machine(s) 302 may be configured by a system different from simulation system 346.

Simulation system 346 may select a subset of available host machine(s) 302. The set of available host machine(s) 302 may include host machine(s) that were configured and launched by simulation system 346 and existing host machine(s) that were configured by one or more other systems. In some embodiments, simulation system 346 may receive a configuration file (not depicted), including a list of identifiers of the selected subset of host machines and/or associated hypervisors.

Simulation system 346 may obtain instance data of each instance of the selected subset of the host machine(s) (e.g., host machine(s) 302A and 302B). Instance data may include IP addresses associated with a selected host machine and/or integrated manager (e.g., integrated manager 328A and/or 328B) may be used to establish an SSH tunnel (e.g., SSH tunnel(s) 350) between the simulation system 346 and the selected host machine(s) (e.g., host machines 302A and 302B). Simulation system 346 may obtain instance data (e.g., an IP address for integrated manager 328A, for a host machine 302A, or the like)) from any suitable source, such as one or more backend servers. In some embodiments, integrated manager 346 may utilize SSH key 352 to establish one of SSH tunnel(s) 350.

In some embodiments, simulation system 346 may establish SSH tunnel(s) 350 respective to the selected host machine(s) (e.g., one or more of host machine(s) 302A and/or 302B). Denote the set of selected host machine(s) by H. In some instances, host machine(s) 302 may be remote with respect to simulation service 344, and simulation service 344 may establish SSH tunnel(s) 350 to one or more host machine(s) 302A or 302B via network 310. Network 310 may be an example of network 110 of FIG. 1.

In some embodiments, simulation system 346 may simulate a power outage LSE by powering down one or more host machine(s) based at least in part on sending respective commands to the host machine(s) integrated manager (e.g., integrated manager 328A and 328B. Simulation system 346 may select a subset of host machines in set H, described above. Denote the set of selected host machines from set H by S. Simulation system 346 may receive a configuration including identifiers associated with the host machines, or corresponding hypervisors, of set S.

In some embodiments, simulation system 346 may send a command to integrated manager 328 of set S via the respective SSH tunnel(s) 350. The command may cause the integrated manager 328 of the host machine to execute operations to cause the respective host machine to power off, simulating a power outage of the corresponding host machine(s) 302A and/or 302B or compute instance(s) 312A and/or 312B.

In some embodiments, simulation system 346 may wait for a configured period (e.g., 45 minutes, 100 minutes, etc.). The wait time may allow the simulated power outage to impact the compute instance(s) 312A and/or 312B of the host machine(s) of the set S.

In some instances, the simulation system 346 may initiate (e.g., launch) validator(s) 348. Validator(s) 348 may be configured to periodically attempt to establish/reestablish an SSH connection (e.g., via SSH tunnel(s) 350) with compute instance(s) 312A or 312B of the host machine(s) of the set S.

In some instances, simulation system 346 may send a command and/or signal (e.g., via SSH tunnel(s) 350) to the host machine(s) of the set S or a subset of S. The power command may be received by integrated managers 328 of the host machine(s) (e.g., host machines 302A and 302B, in this example) receiving the command. Validator(s) 348 may periodically attempt to establish connections to respective compute instance(s) (e.g., by attempting to establish an SSH tunnel). Simulation system 346 may measure data plane recovery for bare metal and virtual machines (e.g., compute instance(s) 312A and 312B, in the ongoing example). For example, simulation system 346 may monitor the time duration for each compute instance to power on and respond to SSH connection attempts by validator(s) 348.

Simulation system 346 may obtain information about the host machine(s) 302 or components therein (e.g., hypervisors, integrated managers, or smart NICS, through proxies or other services provided by the backend service(s) 340. For example, the simulation system may obtain the information about hypervisors (e.g., hypervisor ID) of host machine(s) 302 that are not configured by the simulation system 346 through a proxy provided by the backend service(s) 340.

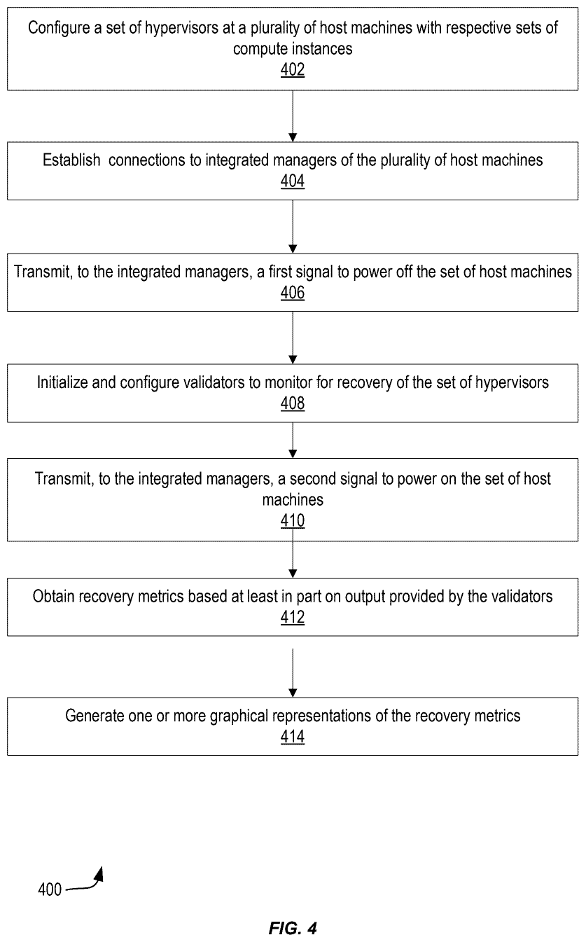

FIG. 4 is a block diagram illustrating an example method 400 for simulating a power outage utilizing a simulation system (e.g., the simulation system 346 of FIG. 346) in accordance with at least one embodiment.

The method may begin at 402, where the simulation system (e.g., simulation system 346) may configure a set of hypervisors (e.g., hypervisors 314A, 314B, and 314C of FIG. 3, collectively, “hypervisors 314”) at a plurality of host machines (e.g., host machine(s) 302A, 302B, and 302C of FIG. 3, collectively, “host machine(s) 302”) with respective sets of compute instances (e.g., compute instance(s) 312A, 312B, and 312C of FIG. 3, collectively, “compute instance(s) 312”). Configuration data (a configuration file such as configuration data 120 of FIG. 1 or a different configuration file not depicted) may be received by the simulation system. The configuration data may identify a set of hypervisors and respective configuration parameters, such as the ones depicted in FIG. 2. By way of example, the configuration data may include the number of compute instances, memory size, cores, or block storage volume. In some embodiments, the configuration data corresponding to the set of hypervisors may be provided via command (e.g., via a command provided via a command line or a graphical user interface).

At 404, the simulation system may establish connections to respective integrated managers (e.g., integrated managers 328A, 328B, and 328C of FIG. 3, collectively, “integrated manager(s) 328”) of the plurality of host machines. The simulation system may establish SSH tunnels (e.g., SSH Tunnel(s) 350, including a tunnel to integrated manager 328C that is not depicted in FIG. 3) to the host machines associated with the configured set of hypervisors. The simulation system may receive or otherwise obtain the information to establish a connection with the integrated manager via a configuration file.

In some embodiments, the integrated manager may include a set of processors. The set of processors may respectively be embedded in the set of computing devices (e.g., host machine(s) 302). The set of processors may be configured to provide a management interface for the set of computing devices. In some embodiments, the firmware on the set of processors of the computing devices (e.g., host machine(s) 302) may respectively be configured to apply power to the set of computing devices, regardless of whether the set of computing devices have been powered on. In some embodiments, the set of processors configured to apply power to the set of computing devices may be additionally, or alternatively, embedded in the integrated manager(s) 328, hypervisor(s) 314.

At 406, simulation system may transmit a signal (e.g., a power command) to the host machine (e.g., to integrated managers 328). The power command may indicate that the set of computing devices (e.g., host machine(s) 302) are to be powered off. In some embodiments, the simulation system may simulate a power outage by executing operations by integrated manager(s) 328 (in response to receiving the power command and/or signal) to power down the respective computing devices (e.g., host machine(s) 302). For example, the simulation system may use the SSH tunnel (e.g., SSH tunnel(s) 350 of FIG. 3) to send a power command to the integrated manager to power down its respective computing device.

In some embodiments, one or more applications may be opened on the set of computing devices when the signal/power command is received. Executing the operations associated with powering down the set of computing devices may cause the closing of at least one of the applications or files without saving the changes.

At 408, the simulation system may initialize and configure validators (e.g., validator(s) 348 of FIG. 3) to monitor for recovery of the set of hypervisors. Initializing and configuring validators may include launching any suitable number of computing threads and/or processes and/or configuring those, or existing threads and/or processors, to monitor for recovery of the set of hypervisors. In some embodiments, a validator may be a process that may perform operations to establish a connection with a hypervisor or a compute instance (e.g., a virtual machine or an application on a virtual machine). For example, the process may send signals to establish an SSH connection with the hypervisor or the integrated manager.

At 410, the simulation system may transmit to the integrated manager another signal to power the set of host machines. The simulation may initiate the restoration and recovery process from a power outage by executing operations (e.g., with or via the integrated manager of a host machine) that are associated with powering up the computing devices that were powered down at step 406. For example, the simulation system may use an SSH tunnel (e.g., SSH tunnel(s) 350) to send a power command to the integrated manager (e.g., integrated manager(s) 328) to power up its respective computing device.

At 412, the simulation system may obtain recovery metrics based on the output provided by the validators. The validators may log the recovery information for their respective hypervisors. For example, a validator may monitor the recovery of its respective hypervisors by sending signals to establish a connection with the hypervisor. The validator may log the timestamp of each signal and/or whether the connection was established. The validator may provide the log to the simulation system.

In some instances, the simulation system may obtain a recovery metric based on the validator's measurements and logs. For example, based on the validator's output measurement or logs, the simulation system may determine the amount of time it takes for a compute instance or hypervisor to recover. In some embodiments, the recovery metric may include minimum, average, median, X percentile (e.g., X=10, 20, 30, 40, 50, 60, 70, 80, or 90 percent), indicating when X percentage of the hypervisors were identified as being recovered, or a maximum hypervisor recovery time.

At 414, the simulation system may generate one or more graphical representations of the recovery metric. For example, graphical representations may illustrate a cumulative distribution of recovered hypervisor or virtual machines over time. Any suitable graphical representation may, in some embodiments, be presented via a graphical user interface.

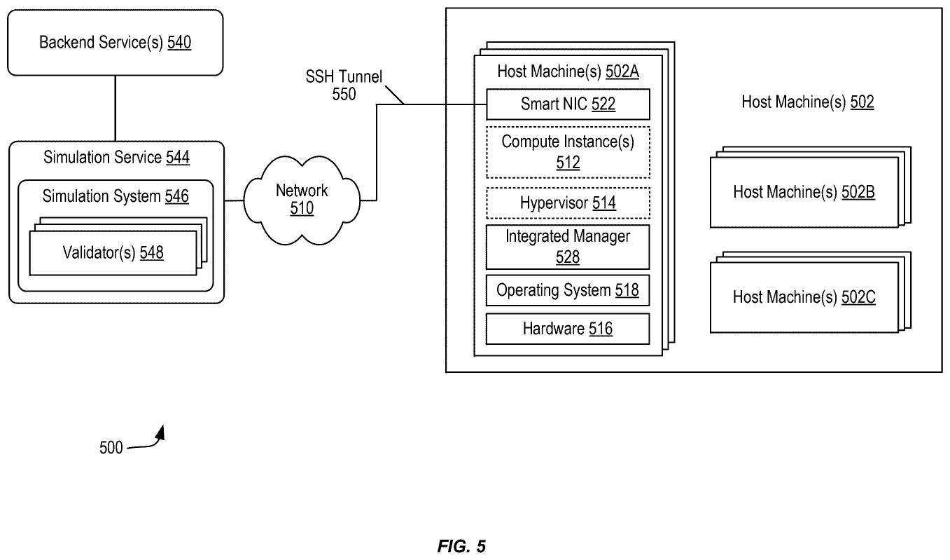

FIG. 5 illustrates a block diagram 500 depicts an example simulation system that is configured to simulate a block storage fault, according to at least one embodiment. Simulation system 546 may simulate the block storage outage by detaching the boot volume from the hypervisor 514. Simulation system 546 may be configured to simulate the restoration of the block storage outage by reattaching the boot volume to the hypervisor 514.

Simulation system 546 may be executed by simulation service 544. Simulation service 544 may be an example of the simulation service 144 or 344 of FIGS. 1 and 3, respectively. Simulation system 546 may be an example of simulation system 346 of FIG. 3. Simulation system 546 may configure host machine(s) 502A, 502B, and or 502C (referred to collectively as “host machine(s) 502”), which individually may be examples of host machine(s) 102 or 302) with the same or different configurations. For example, different configurations may have different parameters for hypervisors 514 (e.g., different resource sizes). Alternatively, or additionally, different configurations may have different parameters for compute instances 512.

Integrated manager 528 may be an example of integrated manager 328 of FIG. 3 and may be configured to perform similar operations as discussed above in connection with FIG. 3. Similarly, operating system 518 and hardware 516 are examples of operating system 318 and hardware 316 of FIG. 3, respectively.

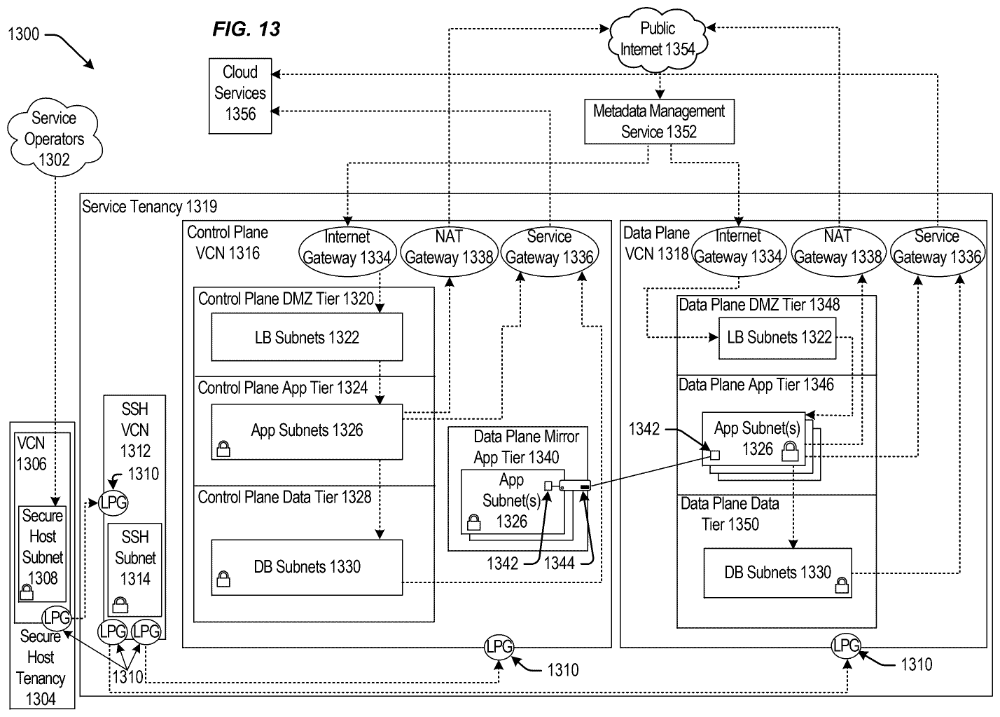

Simulation system 546 may establish an SSH tunnel 550 via network 510 to smart NIC 522. Network 510 may be an example of network 110 in FIG. 1. Smart NIC 522 may be an example of smart NIC 122 of FIG. 1. Smart NIC 522 may control and maintain connectivity between hypervisor 514 and its associated boot volume. In some embodiments, simulation system 546 may obtain IP addresses and/or substrate IP addresses for the smart NIC 522, with which the SSH tunnel 550 may be established. By way of example, an IP address for a bare metal instance (or virtual machine) such as compute instance 512 may be obtained and used to obtain a substrate IP address for the smart NIC 522. SSH tunnel 550 may be established using an IP address (e.g., the substrate IP address corresponding to a substrate virtual network in which services (e.g., cloud services 1356 of FIG. 13, of which simulation system 546 may be an example) participate). In some instances, simulation system 546 may obtain IP addresses and/or substrate IP addresses for the smart NIC 522 from a backend service(s) 540.

Simulation system 546 may generate and send a signal and/or command (e.g., via SSH tunnel 550) to smart NIC 522 to simulate a block storage LSE. The signal and/or command may cause smart NIC 522 to detach hypervisor 514 from its boot volume (e.g., one of boot volume(s) 126 of FIG. 1). Simulation system 546 may be configured to generate and send another signal and/or command to smart NIC 522 to restore the system. The signal and/or command may cause smart NIC 522 to attach/reattach hypervisor 514 to its boot volume.

Simulating a block storage failure LSE may include the following steps. In step one, simulation service 544 may launch and configure instances of host machine(s) 502, hypervisor 514, and/or compute instance(s) 512. Launching and configuring the resources may be based on a configuration file (e.g., launch configuration 200 of FIG. 2) that provides an identifier of the resources (e.g., hypervisor ID and configurations.

In step 2, the simulation system 546 may detach the boot volume associated with hypervisor 514. In some embodiments, simulation system 546 may detach the boot volume associated with each of the hypervisors of the set of hypervisors. The set of hypervisors may be identified in a configuration file (e.g., configuration data 120 of FIG. 1) or a different configuration file. In some embodiments, the hypervisors may be identified by a set of identifiers either in a configuration file or provided via a command line interface or graphical user interface. The set of hypervisors in step 2 may be different than the set of hypervisors that were launched or configured in step 1.

In some embodiments, detaching the set of hypervisors may include transmitting a signal and/or command to smart NIC 522 to detach a corresponding boot volume. In some embodiments, smart NIC 522 may execute a script to detach the boot volume(s). At any suitable time, smart NIC 522 may execute operations to obtain and/or store data associated with the boot volume and/or the detachment for subsequent use. By way of example, smart NIC 522 may capture any suitable data (e.g., IP addresses, substrate IP addresses, etc.) associated with the boot and/or data volumes attached to the compute instance(s) 512. For example, smart NIC 522 may obtain IP addresses for hypervisor 514 and/or bare metal or virtual machine(s) such as computer instance(s) 512. In some embodiments, these IP addresses may include addresses from multiple virtual networks. This data may be stored for subsequent use (e.g., to power on or reattach boot volumes).

In step 3, simulation system 546 may initiate and/or configure validator(s) 548 and assign them respectively to a set of hypervisors and/or virtual machines (e.g., compute instance(s) 512). The set of hypervisors in this step may be different from the set of hypervisors in steps 2 or 1. In one example, the set of hypervisors in this step is the same as the set of hypervisors in step 2. Validator(s) 548 may monitor the status of the hypervisor 514 and/or its virtual machines (e.g., compute instance(s) 512) and may create and/or store a log file based at least in part on the monitoring. In some embodiments, monitoring the connection may include transmitting metrics associated with the monitoring to one or more logging services (e.g., logging service 142 of FIG. 1).

After causing the boot volume to be detached, the boot volume may become read-only. In some embodiments, the boot volume may become read-only after a time period (e.g., 100 minutes, 10 seconds, substantially immediately, or the like). The host machine(s) 502 or the hypervisor 514 may not immediately notice that the boot volume is not available or is in a read-only state. In some instances, the host machine(s) 502 may reboot themselves to make their boot volume writeable again. In some embodiments, after a configured period (e.g., 100 minutes), the host machine may be rebooted. By way of example, a computing process (e.g., watchdog daemon 134 of FIG. 1) executing on the host machine(s) 502 (e.g., as part of hypervisor 514) may monitor the status of the boot volume by periodically sending write checks to the boot volume. The computing process may determine that the boot volume is in a read-only state when the computing process receives one or more (e.g., consecutive) error messages in response to sending write checks to the boot volume. If the boot volume remains read-only for the configured period, the computing process may initiate rebooting the host machine(s) 502 of hypervisor 514 associated with the boot volume that is in read-only state. In some embodiments, the computing process may perform operations to instruct the integrated manager 528 to reboot the machine.

In some embodiments, validator(s) 548 may start measuring the recovery time once their respective host machine(s) start rebooting. After reboot, the validators may periodically attempt to connect to a corresponding hypervisor (e.g., hypervisor 514) via an SSH tunnel.

In step 4, when an SSH tunnel has been established between a validator and the hypervisor 514 is successful, simulation system 546 may send a signal and/or a command (e.g., a “reattach command/signal”) to smart NIC 522. The command/signal may cause smart NIC 522 to attach (e.g., reattach) hypervisor 514 to its corresponding boot volume. In some embodiments, steps 2 and 4 commands may be transmitted using the SSH tunnel 550.

The validators may periodically attempt to establish SSH tunnels to compute instances (e.g., compute instance) operating on any suitable hypervisor (e.g., hypervisor 514). A recovery time for the hypervisor 514 may be measured as the time between sending the signal to detach and the time when some number of the compute instance(s) of a hypervisor (e.g., one, all, etc.) are able to establish an SSH tunnel. For example, the recovery time of hypervisor 514 may be measured as the amount of time clapsing from time T1, when the smart NIC 522 was commanded/instructed to detach hypervisor 514 from its boot volume, and time T2, when every compute instance by hypervisor 514 (e.g., compute instance 512) is able to establish an SSH tunnel with simulation system 546 (e.g., with a validator of validator(s) 548).

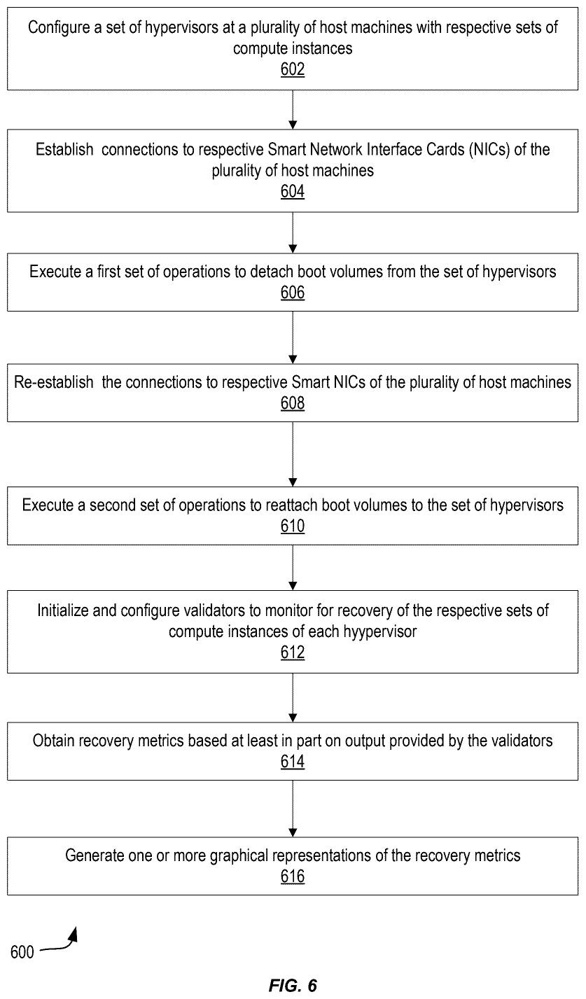

FIG. 6 is a block diagram illustrating an example method 600 for simulating a block storage outage utilizing a simulation system (e.g., simulation system 546 of FIG. 5) in accordance with at least one embodiment.

The method may begin at 602, where the simulation system may provision and/or configure a set of hypervisors (e.g., hypervisor 514 of FIG. 5) at a plurality of host machines (e.g., including host machine(s) 502 of FIG. 5) with respective sets of compute instances (e.g., compute instance 512 of FIG. 5). A configuration file (e.g., configuration file 120 of FIG. 1) may identify the set of hypervisors and respective configurations. In other embodiments, identifiers and/or configuration parameters for the set of hypervisors can be provided via an interface (e.g., a command line interface, an application programming interface, a graphical user interface, etc.). The hypervisor configuration may include the number of compute instances, memory size, cores, or block storage volume.

At 604, the simulation system may establish connections to respective smart NICs (e.g., smart NIC 522 of FIG. 5) of the plurality of host machines. The simulation system may establish SSH tunnels (e.g., SSH tunnel 550 of FIG. 5) to the smart NICs associated with the configured set of hypervisors. The simulation system may receive the information to establish a connection with smart NIC 550 via a configuration file or, in some embodiments, the information (e.g., IP address, a substrate IP address corresponding to a substrate network) with which the connection may be established may be obtained from one or more backend service(s) 540. Backend service(s) 540 may be an example of backend service(s) 340 of FIG. 3.

In some embodiments, the smart NICs may include a set of processors. The set of processors may respectively be embedded in the set of computing devices (e.g., smart NIC 522, host machine(s) 502, hypervisor 512 of FIG. 5). The set of processors may be configured to provide one or more I/O interfaces for the set of computing devices.

At 606, the simulation system may execute a set of operations to detach boot volumes from the set of hypervisors. In some instances, the simulation system may transmit a signal (e.g., a detach command) to the smart NIC (e.g., via SSH tunnel 550 of FIG. 5). The detach command may indicate to detach the set of hypervisors from their respective boot volumes. In some cases, this command may cause the smart NIC to execute one or more operations and/or scripts that cause the boot volumes of the hypervisors to detach.

In some embodiments, one or more applications may be opened on the set of computing devices. Executing the operations associated with detaching the set of hypervisors from their respective boot volumes may, eventually, cause at least one of the applications or files to close without saving the changes. For example, detaching a hypervisor from its respective boot volume may cause the boot volume to become read-only. A process (e.g., watchdog daemon 126 of FIG. 1, operating on the hypervisor or elsewhere at the host device) may detect that the boot volume has become read-only and may reboot the host machine associated with the hypervisor. In some embodiments, the host machine may be rebooted after a predefined period of time (e.g., 50 minutes, 100 minutes, 30 seconds, or the like). Rebooting the host machine may result in applications or files on virtual machines running on the host machine closing without saving the changes.

At 608, the simulation system may re-establish the connections to respective smart NICs in a similar manner as described by operations at 604. In some embodiments, the connection may be an SSH tunnel.

At 610, the simulation system may execute a second set of operations to reattach boot volumes to the set of hypervisors. The simulation system may transmit a command to reattach the set of hypervisors to their respective boot volumes. The simulation may initiate the restoration and recovery process from a block storage outage LSE by executing operations on the smart NICs associated with reattaching the hypervisors that were detached from their boot volumes at step 606.

At 612, the simulation system may initialize and configure validators (e.g., validator(s) 548 of FIG. 5) to monitor for recovery of each hypervisor's respective sets of compute instances. The validators may establish SSH connections to their respective compute instances. In some embodiments, validators may monitor the recovery of hypervisors. In some embodiments, the validator(s) may measure the time of recovery as being the time between T1, when the command to reattach was received and/or executed (e.g., at the smart NIC), and T2, the time at which SSH tunnels have been established to one or more (e.g., all) compute instances managed by the hypervisor.

At 614, the simulation system may obtain recovery metrics based on the output provided by the validators. The validators may log the recovery information for their respective hypervisors. For example, a validator may monitor the recovery of its respective hypervisors by sending signals to establish a connection with the hypervisor. The validator may log the timestamp of each signal and whether the connection was established. The validator may provide the log to the simulation system. In some embodiments, the validators and/or the simulation system may provide the recovery metrics to a logging service (e.g., the logging service 142 of FIG. 1).

In some instances, the simulation system may obtain a recovery metric based on the validator's measurements and logs. For example, based on the validator's output measurement or logs, the simulation system may determine the amount of time it takes for a compute instance or hypervisor to recover. In some embodiments, the recovery metric may include minimum recovery time (e.g., the minimum time any hypervisor of the set of hypervisors took to recover), an average recovery time (e.g., the average time period for recovery from the recovery times of the set of hypervisors), a median recovery time, X percentile (e.g., X=10, 20, 30, 40, 50, 60, 70, 80, or 90) indicating a time at which X percentage of the compute instances of the set of hypervisors or a percentage of the set of hypervisors is determined to be recovered, or a maximum hypervisor recovery time (e.g., the maximum time any hypervisor of the set of hypervisors took to recover).

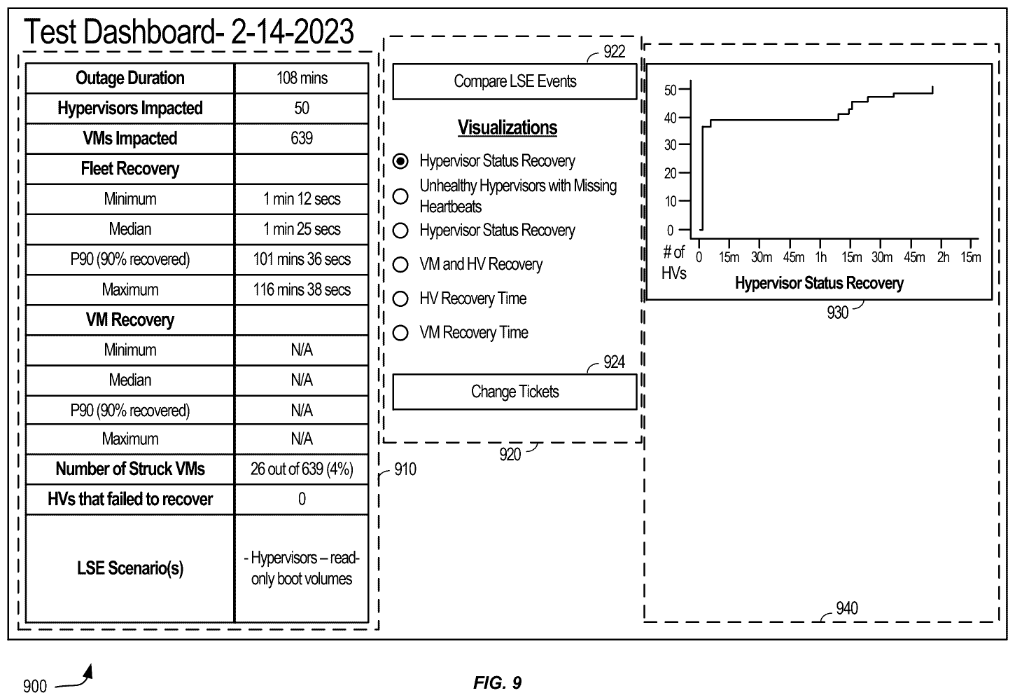

At 616, the simulation system may generate one or more graphical representations of the recovery metric. For example, graphical representations may illustrate a cumulative distribution of recovered hypervisor or virtual machines over time. In another example, graphical representations may illustrate recovery time (e.g., average recovery time) over time for different simulated LSEs. In another example, the graphical representation may illustrate a cumulative distribution of recovery time of hypervisors or virtual machines. In some embodiments, these graphical representations may be provided at a user interface (e.g., user interface 900 of FIG. 9, discussed in further detail below).

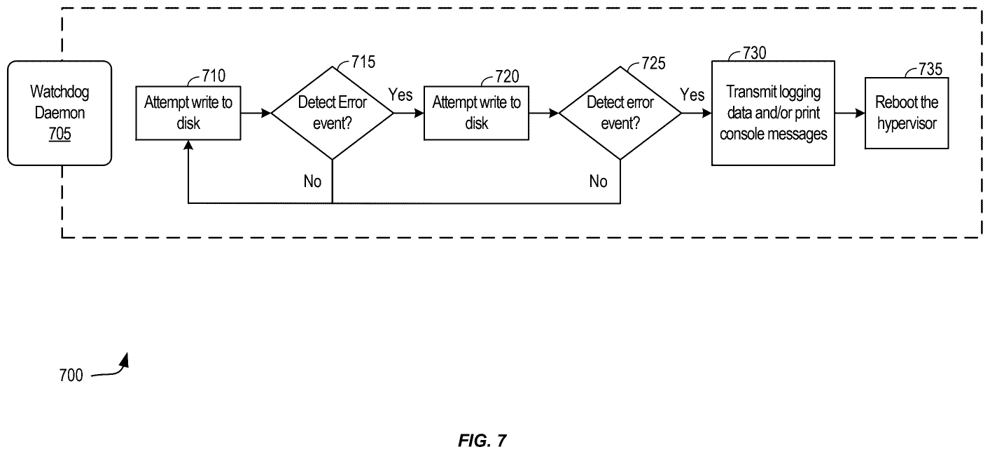

FIG. 7 is a block diagram illustrating an example method 700 utilizing watchdog daemon 705 for detecting and recovering from hypervisor unresponsiveness, according to at least one embodiment. Watchdog daemon 705 may be an example of watchdog daemon 134 in FIG. 1.

Watchdog daemon 705 may be a system-managed service. In some embodiments, watchdog daemon 705 may be associated with a memory limit (e.g., a memory limit of 0.5, 1, 2, or 4 gigabytes (GB)), a task limit (e.g., a task limit of 10, 20, 50, 100, etc.), or a disk limit (e.g., a disk limit of 0.5, 1, 2, or 4 GB).

The method may begin at 710, where watchdog daemon 705 may attempt a write check. Attempting a write check may include transmitting to the hypervisor's boot volume or a service that manages the hypervisor's boot volume, a disk write request that requests data to be written to the hypervisor's boot volume, In some embodiments, the watchdog daemon 705 may be configured to attempt write checks according to a predefined schedule or periodicity or on demand.

At 715, watchdog daemon 705 may determine whether an error event has been detected. In some embodiments, determining whether an error event has been detected includes determining whether an error code from the hypervisor's boot volume was received in response to a write check. Determining whether an error event has been detected may include determining whether an error input/output (EIO) error code or an error read-only file system (EROFS) error code has been received in response to the write check. In some cases, receipt of EIO and EROFS error codes may be indicative of a read-only boot volume, while other error codes may not. In some embodiments, watchdog daemon 705 may detect (e.g., via the EIO and/or EROFS error codes) any suitable combination of an SCSI command timer expiration, an iSCSI replacement timer expiration, or an iSCSI session logout.

In some embodiments, the simulation service (e.g., simulation service 144 of FIG. 1 or simulation service 544 of FIG. 5) may simulate an outage (e.g., power outage), or a fault (e.g., a block storage fault). Simulating an outage or a fault may cause the hypervisor to detach from its boot volume or otherwise become non-responsive or unaccessible. When the boot volume is detached or becomes unaccessible, the boot volume may not respond to watchdog daemon write check attempts. In some instances, watchdog daemon may receive an error message when boot volume does not respond to write check attempts. The watchdog daemon may determing that an error event has been detected.

If watchdog daemon 705 determines that no error codes (or particular error codes such as the EIO and/or EROFS error codes) have been received in response to the previous write check, the method may return to 710 to continue performing periodic write checks.

Alternatively, if an error event is detected at 715 (e.g., the watchdog daemon 705 determines that an EIO or EROFS error code has been received in response to the write check performed at 710), the method may proceed to 720. Alternatively, in some embodiments, when an error event is detected at 715, the watchdog daemon 705 may determine that the boot volume is operating in a read-only mode, and method 700 may proceed to step 730.

At 720, watchdog daemon 705 may attempt a second write check. The second write check may be performed to verify that the hypervisor's boot volume is in read-only mode. The second write check may be used to ensure that the previously detected read-only state was not transitory and to ensure that reboots of the hypervisor are not needlessly performed. The second write check may include transmitting another disk wright request to the hypervisor's boot volume (or corresponding managing system, such as a block volume storage service of Cloud Infrastructure Service(s) 140 of FIG. 1). In some embodiments, the watchdog daemon 705 may be configured to transmit the second write check by/within a certain amount of time after transmitting the first write check. By way of example, watchdog daemon 705 may initiate a timer upon detecting the error event at 715. The expiration of the timer may trigger the transmission of the second write check. In some embodiments, the second write check may be transmitted regardless of the time at which the first write check was transmitted.

At 725, watchdog daemon 705 may determine whether an error event has been received in response to the most recently transmitted write check. As discussed above, the watchdog daemon 705 may detect an error event has occurred (e.g., indicating that the hypervisor's boot volume is in a read-only mode) based at least in part on determining that an error input/output (EIO) and/or an error read-only file system (EROFS) error code has been received.

If watchdog daemon 705 determines that no error codes (or particular error codes such as the EIO and/or EROFS error codes) have been received in response to the previous write check, the method may return to 710 to continue performing periodic write checks.

In some embodiments, the watchdog daemon 705 may be configured to determine that the hypervisor's boot volume is in a read-only mode (and/or that the boot volume has been verified as being in a read-only mode) based at least in part on detecting any suitable combination of the error events at 715 and/or 725. In some embodiments, the watchdog daemon 705 may determine that the boot volume is operating in a read-only mode only after the (second) error event is detected at 725. If the watchdog daemon determines/verifies that the boot volume is in a read-only mode, the process may proceed to step 730.

At 730, based on detecting and/or verifying that the boot volume is operating in a read-only mode, watchdog daemon 705 may transmit logging data and/or print one or more console messages. In some embodiments, the data may be associated with the error event and may include any suitable combination of an event identifier, an identifier associated with the watchdog daemon 705, an identifier associated with the hypervisor, an identifying associated with the boot volume, a timestamp corresponding to a time at which the boot volume was determined to be operating in the read-only mode, the one or more error code(s) on which the read-only determination was based, corresponding times at which the one or more error code(s) were received, or any suitable data corresponding to the error event. In some embodiments, the data may be transmitted to logging service(s) 142 of FIG. 1. In some embodiments, the data may be transmitted to the integrated manager 124 of FIG. 1 and persisted in local memory. Although depicted as occurring prior to rebooting the hypervisor at 735, the operations performed at 730 may alternatively be executed subsequent to the operations performed at 735. In either case, the data may include an indication of whether watchdog daemon 134 attempted to reboot the hypervisor.

In embodiments in which watchdog daemon 705 transmits logging data to one or more logging services, the watchdog daemon 705 may use a monitoring software development kit (SDK) for the transmission. At least one logging service may be a lightweight service that provides a point-in-time view of service health, even during large-scale events (e.g., outages that affect a large number of computing components). A lightweight logging service may have few dependencies, so it can survive incidents that may impact many core services.

In some embodiments, any suitable combination of domain name server (DNS) data, a transport layer security (TLS) certificate, and/or a public key infrastructure (PKI) certificate may be stored in the local memory of a device that hosts the hypervisor to enable transmitting and/or logging the data with the one or more logging services. In some embodiments, the DNS data, the TLS certificate, and/or the PKI certificate may be included in the hypervisor's image and stored in local memory during the deployment and/or installation of the hypervisor and/or watchdog daemon 134. In some cases, any suitable combination of the DNS data, the TLS certificate, and/or the PKI certificate may be deployed and/or otherwise stored in the memory of a corresponding host machine on which the hypervisor and watchdog daemon 134 execute at any suitable time and/or as part of a separate process to configured the watchdog daemon/host machine with data needed for successful transmissions and/or logging of data with the one or more logging services.

In some embodiments, watchdog daemon 705 may be configured to print a console message after detecting a read-only boot volume. Printing a console message may include transmitting data to be included in the console message to an integrated manager (e.g., integrated manager 124 of FIG. 1). The data of the console message may be the same or different from the logging data discussed above. In some embodiments, the console message may include any suitable combination of the attributes of the logging data discussed above. In some embodiments, watchdog daemon 705 may print the console message before the hypervisor reboot. Transmitting data to the integrated manager may cause the data to be stored locally (e.g., as integrated manager data) and persisted in local memory (e.g., a portion of a local hard drive, local hard drive space dedicated and/or assigned to the hypervisor, etc.) at the device hosting the hypervisor.

At 735, watchdog daemon 705 may execute any suitable operations to cause a reboot of the hypervisor (e.g., hypervisor 114) based on determining that the boot volume associated with the hypervisor is in read-only mode. By way of example, the watchdog daemon 705 may transmit instructions or any suitable signal to a baseboard management controller (e.g., also referred to as an “integrated manager”) to reboot the host machine. In some embodiments, watchdog daemon 705 may reboot the hypervisor at a preconfigured time after printing the console message and/or logging the data at 730. While waiting to reboot, watchdog daemon 705 may send one or more notifications to a user and/or the operator. The notification(s) may include any suitable data associated with the error event, the watchdog daemon 705, the hypervisor, the boot volume, the particular error codes detected/received, time(s) at which the error code(s) were received, a time at which the read-only mode of the boot volume was determined, or the like. The notification(s) may include an indication that watchdog daemon 705 plans to reboot the hypervisor and/or that the watchdog daemon 705 has executed operations to reboot the hypervisor. In some embodiments, watchdog daemon 705 may be restricted from rebooting the hypervisor unless the hypervisor has been running for longer than a predefined time period (e.g., 1 hour, 2 hours, a day, etc.).

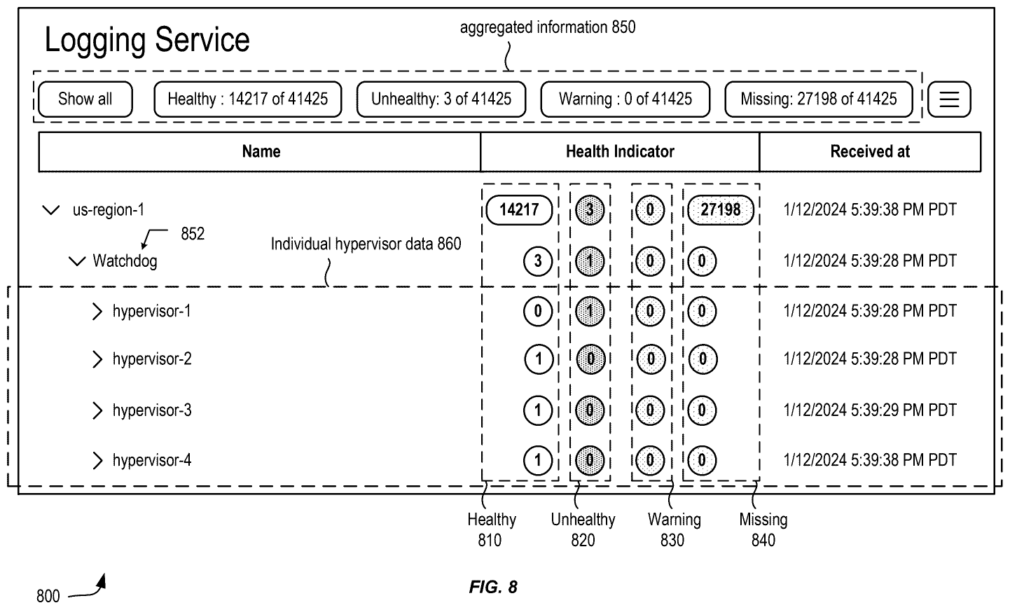

FIG. 8 is a block diagram depicting an example graphical interface 800 of a logging service, according to at least one embodiment.

In one example, the logging service may provide historical data (e.g., past events such as outages, reboots, or error messages. In another example, the logging service may provide a point-in-time view of service health. The graphical interface 800 is an example of a graphical interface of a logging service that provides a point-in-time view of service health.

The graphical interface 800 may include a section to display aggregated information 850. In some embodiments, the aggregated information 850 may indicate any suitable combination of a number of healthy hypervisors, a total number of hypervisors, a total number of unhealthy hypervisors, or the like. As depicted in FIG. 8, aggregated information 850 may include a total number of warnings and/or a total number of hypervisors for which health status is missing/unknown.

The graphical interface 800 may include information for each hypervisor. The entries on the healthy column 810, unhealthy column 820, warning column 830, or missing column 840 may provide information for components of the CSPI 108. For example, the information associated with “us-region-1” indicates that, in a data center corresponding to “us-region-1,” there are 1427 healthy hypervisors, 3 unhealthy hypervisors, 27198 hypervisors for which status is missing/unknown, and no warnings have been received.

In some embodiments, the graphical interface 800 may provide individualized information for each hypervisor. For example, the entry of the healthy column 810 for hypervisor-2 has a value of ‘1’ and may indicate that the hypervisor-2 is a healthy hypervisor. The entry of the unhealthy column 820 for hypervisor-1 has a value of ‘1’ and may indicate that hypervisor-1 is an unhealthy hypervisor. The graphical interface 800 may also include a region that provides the date and time associated with the status of the hypervisors. For example, a region of the graphical interface 800 may include information that indicates that the hypervisor-3 status information was received on at Jan. 12, 2024 5:39:29 PM PDT. In some embodiments, any suitable portion of the graphical interface 800 may be collapsed or expanded using interface elements similar to interface element 852. Interface element 852 may correspond to a toggle with which watchdog data may be collapsed (e.g., to hide individual hypervisor data 860) or expanded (e.g., to view the individual hypervisor data 860).

FIG. 9 is a block diagram depicting an example user interface 900 (e.g., a graphical user interface) of a simulation service, according to at least one embodiment. User interface 900 may include an area 910 that is configured to display the numerical values of the LSE and measured metrics; an area 930 to display graphs or charts associated with the recovery metrics; and an area 920 to allow selection of parameters associated with the visualization 930.

In some embodiments, area 910 may display the numerical value of a selected LSE and measured metrics. Area 910 may include information about the configurations of the simulated LSE (e.g., the number of hypervisors, virtual machines, name, date, and duration of the simulation). Additionally or alternatively, area 910 may display LSE measurement metrics such as a minimum recovery time, a median recovery time, and X percentile (e.g., 90 percentile), indicating an elapsed time by which at least X percentage of the hypervisors were determined to have been recovered, and a maximum recovery time for hypervisors (e.g., fleet) and/or virtual machines.

In some embodiments, area 920 may allow for selecting the LSE and comparison or visualization parameters. In some embodiments, change tickets may be generated based, at least in part, on the selection of option 924. Selecting option 924 may allow for a new change ticket (e.g., a ticket indicating a bug fix, patch, or other update is needed) to be generated. In some embodiments, generating a new change ticket may include associating the change ticket with any suitable data corresponding to a simulation (e.g., the data provided in area 910 and/or the graphical visualizations such as graphical representations provided via visualization 930.

In some embodiments, area 920 may allow for the selection of parameters of one or more graphs (e.g., visualization 930) and/or charts. For example, in area 920, the user may select to plot hypervisor status recovery to illustrate the cumulative number of recovered hypervisors over time or other plots such as hypervisor recovery time, virtual machine recovery time, both hypervisors and virtual machines recovery times, etc. Additionally, or alternatively, area 920 may include option 922, allowing the user to compare the selected LSE with one or more other simulated or actual LSE instances.

In some embodiments, visualization 930 may be presented in an area configured to display one or more graphs, plots, or charts to visualize the measurement metrics of the selected LSE. For example, in FIG. 9., “hypervisor status recovery” is selected in area 920, and the corresponding graph (e.g., visualization 930) is displayed in area 940.

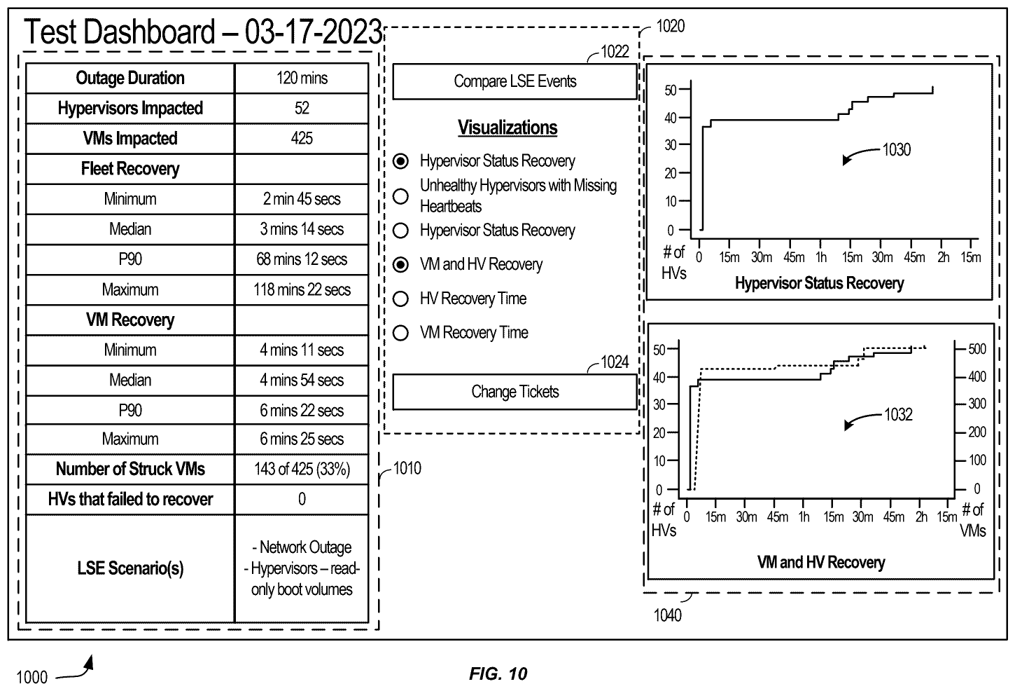

FIG. 10 is a block diagram depicting an example graphical interface 1000 of another simulation service (e.g., the simulation service 144 of FIG. 1), according to at least one embodiment. Areas 1010, 1020, and 1030 are similar to areas 910, 920, and 940 in FIG. 9. Option 1024 is similar to option 924 of FIG. 9 and may be used to generate a new change ticket with the data provided in area 1010. For example, the LSE instance may be related to the “Test Dashboard-Mar. 17, 2023.” Area 1010 may display the numerical values of simulation or event configurations as well as the measured recovery metrics, as described above in area 910 of FIG. 9.

In this example, in area 1020, two recovery metrics are selected in area 1020 (e.g., “Hypervisor Status Recovery” and “VM and HV Recovery”). No other event is selected by comparing LSE events 1022 for comparison. Area 1040 for graphs and charts may reflect the selections made in area 1020.

Area 1040 includes a visualization 1030. Visualization 1030 includes a first plot corresponding to the selected “Hypervisor Status Recovery” option in area 1022. Visualization 1030 illustrates the hypervisor status recovery over time. Area 1040 also includes visualization 1032. Visualization 1032 includes a second plot corresponding to the selected “VM and HV Recovery” option. Visualization 1032 illustrates the recovery of virtual machines and hypervisors over time (e.g., the number of recovered virtual machines and hypervisors over time).

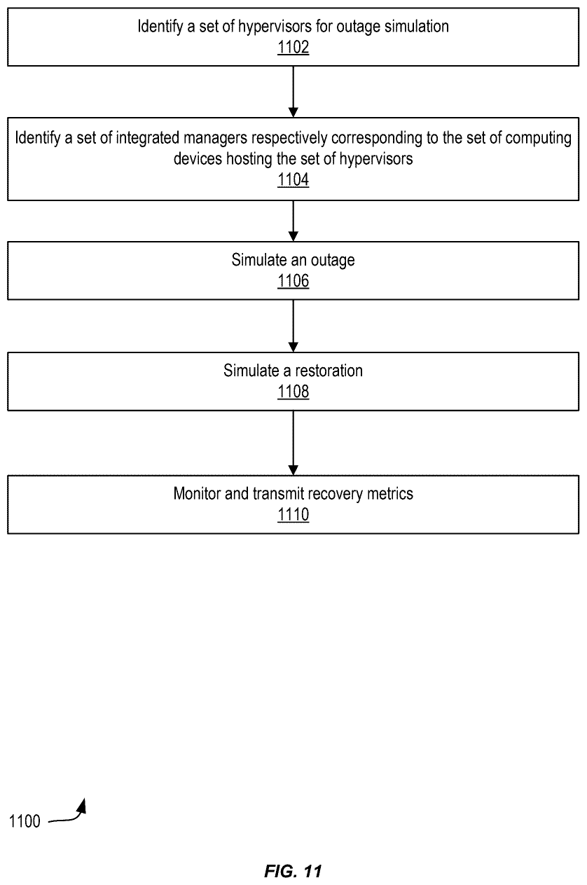

FIG. 11 is a block diagram illustrating an example of method 1100 for simulating an outage in accordance with at least one embodiment.

The method may begin at 1102, where the simulation system (e.g., simulation system 346) may identify a set of hypervisors (e.g., hypervisors 114 of FIG. 1 or hypervisors 314 of FIG. 3) for simulating an outage. A set of computing devices (e.g., host machine(s) 102 of FIG. 1 or host machine(s) 302 of FIG. 3) may host the set of hypervisors. In one example, each hypervisor may be associated with a computing device.

In some embodiments, the set of hypervisors is previously configured. In some embodiments, the simulation system may configure some or all of the hypervisors.

At 1104, the simulation system may identify a set of integrated managers (e.g., integrated manager 124 of FIG. 1 or integrated manager(s) 328 of FIG. 3). The set of integrated managers may include one or more integrated managers. In one example, each integrated manager may be associated with a computing device.

In some embodiments, an integrated manager may include a processor (or processing circuitry) that is embedded in the corresponding computing device. The processor may be configured to provide a management interface (or interface circuitry) for the corresponding computing device.

In some embodiments, an integrated manager may include firmware. The firmware may be executed on the processor of the integrated manager. The firmware may be configured to perform operations associated with powering down or powering up the corresponding computing device. The firmware may be configured to power up its corresponding computing device even when the computing device is powered down.

At 1106, the simulation system may simulate an outage. The simulation system may simulate an outage by executing a set of operations by each integrated manager of the set of integrated managers. The set of operations may include one or more operations associated with power down computing devices. The outage may be simulated by executing operations on the integrated manager of a computing device that may cause the computing device to power down.

In some embodiments, the simulation system may send one or more instructions to the integrated manager to power down the corresponding computing device. The simulation system may send similar instructions to the set of integrated managers to power down the set of respective computing devices.

In some embodiments, one or more applications or files may be open or executed on the computing device when the corresponding firmware executes the powering down operation. The execution of powering down operations may cause the computing device to shutdown. The shutdown of the computing device may cause at least one of the applications or files to close without saving changes.

At 1108, the simulation system may simulate a restoration. The simulation system may simulate the restoration by executing a set of operations by each integrated manager of the set of integrated managers. The set of operations may include one or more operations associated with powering up the computing device. The restoration may be simulated by executing operations on the integrated manager of a computing device that may cause the computing device to power up.

In some embodiments, the simulation system may send one or more instructions to the integrated manager to power up the corresponding computing device. The simulation system may send similar instructions to the set of integrated managers to power up the set of respective computing devices.

At 1110, the simulation system may monitor and transmit recovery metrics. The recovery metrics may be associated with the recovery of the set of hypervisors responsive to simulating the restoration.

In some embodiments, the recovery of a hypervisor is determined by confirming that the connection to the computing device is established after the simulation system starts simulating the restoration. For example, after simulating the restoration, the simulation system may check the connection to a computing device that was powered down. The simulation system may measure the time it takes to establish a connection to the computing device.

In some embodiments, the simulation system may transmit results of comparing the recovery metric against a predefined threshold or historically derived value for the recovery metric.

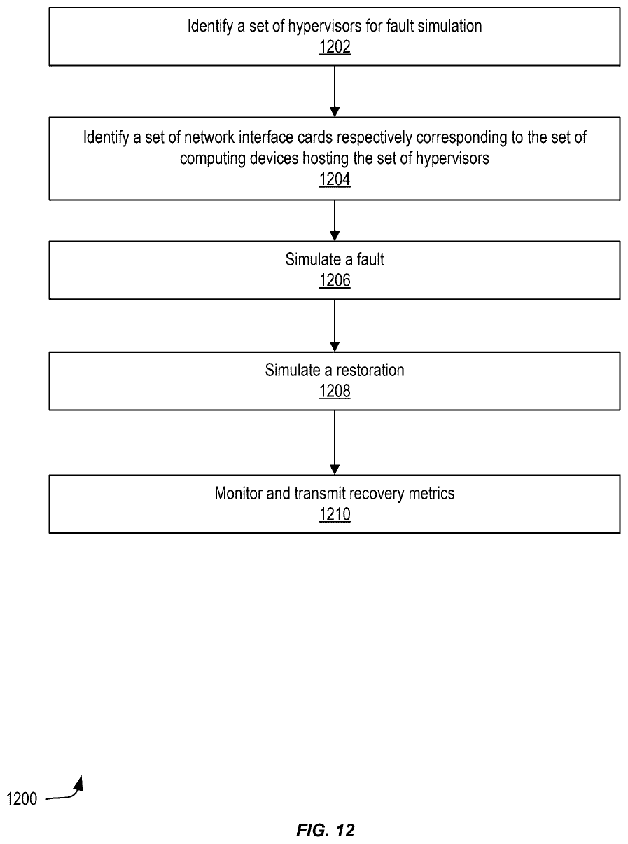

FIG. 12 is a block diagram illustrating an example of method 1200 for simulating a fault in accordance with at least one embodiment.

The method may begin at 1202, where the simulation system (e.g., simulation system 346) may identify a set of hypervisors (e.g., hypervisors 114 of FIG. 1 or hypervisors 314 of FIG. 3) for simulating an outage. A set of computing devices (e.g., host machine(s) 102 of FIG. 1 or host machine(s) 302 of FIG. 3) may host the set of hypervisors. In one example, each hypervisor may be associated with a computing device. Each hypervisor may be associated with a boot volume.

In some embodiments, the set of hypervisors is previously configured. In some embodiments, the simulation system may configure some or all of the hypervisors.

At 1204, the simulation system may identify a set of network interface cards (e.g., smart NIC 122 of FIG. 1 or smart NIC 522 of FIG. 5). The set of network interface cards may include one or more integrated managers. In one example, each network interface card may be associated with one or more computing devices.

In some embodiments, a network interface card may include a processor (or processing circuitry) that is embedded in the network interface card. The processor may be configured to provide a management interface (or interface circuitry) for the corresponding network interface card.

In some embodiments, an integrated manager may include firmware. The firmware may be executed on the processor of the network interface card. The firmware may be configured to perform operations associated with detaching the boot volume from its corresponding hypervisor.

In some embodiments, when the computing device detects that the boot volume is detached, the computing device may perform a reboot process to re-establish the connection with the boot volume. An integrated manager (e.g., integrated manager 124 of FIG. 1 or integrated manager(s) 328 of FIG. 3) of the computing device may power down and power up the computing device to connect to the boot volume.

At 1206, the simulation system may simulate a fault. The simulation system may simulate a fault by executing a set of operations by each of the network interface cards from the set of network interface cards. The set of operations may include one or more operations associated with detaching the set of boot volumes respectively from the set of hypervisors.

In some embodiments, the simulation system may send one or more instructions to the network interface card. The simulation system may send or execute a detach command to the network interface card to cause the hypervisor of the computing device associated with the network interface card to detach from its boot volume. The simulation system may send similar instructions to the set network interface cards to detach the set of boot volumes from their respective hypervisors.

In some embodiments, one or more applications or files may be open or executed on the computing device when the corresponding firmware executes the fault operation, e.g., the block storage fault operation. The execution of the fault operation may cause the computing device to shutdown. The shutdown of the computing device may cause at least one of the applications or files to close without saving changes.

At 1208, the simulation system may simulate a restoration. The simulation system may simulate the restoration by executing a set of operations by each network interface card of the set of network interface cards. The set of operations may include one or more operations associated with attaching a boot volume to a hypervisor. The restoration may be simulated by executing operations on the network interface cards associated with a computing device that may cause the hypervisor of the computing device to attach to its corresponding boot volume.

In some embodiments, the simulation system may send one or more instructions to the network interface card to attach (or reattach) the hypervisor of the corresponding computing device to its boot volume. The simulation system may send similar instructions to the set of network interface cards to reattach the set of hypervisors to their respective boot volumes.

In some embodiments, the boot volume of a hypervisor may become read-only. A process (e.g., a watchdog daemon) associated with a hypervisor may send write requests to the boot volume. In response to the write requests, the watchdog may receive an error message. The watchdog may detect, at least in part based on the write requests or receiving the error message, that the boot volume is in a read-only mode. In response to detecting that the boot volume is in a read-only mode, the watchdog may initiate a reboot operation of the hypervisor. Rebooting the hypervisor may cause at least one of the applications or files running on the hypervisor to close without saving changes.

At 1210, the simulation system may monitor and transmit recovery metrics. The recovery metrics may be associated with the recovery of the set of hypervisors responsive to simulating the restoration.

In some embodiments, the recovery of a hypervisor is determined by confirming that the connection to the computing device is established after the simulation system starts simulating the restoration. For example, simulating the restoration may include initializing one or more validation processes. The validation processes may be configured to periodically attempt to establish connections to the computing devices. The simulation system may measure the time it takes to establish (reestablish) a connection to the computing device.

In some embodiments, the simulation system may transmit results by comparing the recovery metric against a predefined threshold or historically derived value for the recovery metric.

### Example IaaS Environments

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider below the hypervisor layer (e.g., the servers, storage, network hardware, and virtualization). Thus, the customer may be responsible for handling (OS), middleware, and/or application deployment (e.g., on self-service virtual machines (e.g. that can be spun up on demand)) or the like.

In some examples, IaaS provisioning may refer to acquiring computers or virtual hosts for use and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable the deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 13 is a block diagram 1300 illustrating an example pattern of an IaaS architecture, according to at least one embodiment. Service operators 1302 can be communicatively coupled to a secure host tenancy 1304 that can include a virtual cloud network (VCN) 1306 and a secure host subnet 1308. In some examples, the service operators 1302 may be using one or more client computing devices, which may be portable handheld devices (e.g., an iPhone®, cellular telephone, an iPad®, computing tablet, a personal digital assistant (PDA)) or wearable devices (e.g., a Google Glass® head-mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general-purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1306 and/or the Internet.

The VCN 1306 can include a local peering gateway (LPG) 1310 that can be communicatively coupled to a secure shell (SSH) VCN 1312 via an LPG 1310 contained in the SSH VCN 1312. The SSH VCN 1312 can include an SSH subnet 1314, and the SSH VCN 1312 can be communicatively coupled to a control plane VCN 1316 via the LPG 1310 contained in the control plane VCN 1316. Also, the SSH VCN 1312 can be communicatively coupled to a data plane VCN 1318 via an LPG 1310. The control plane VCN 1316 and the data plane VCN 1318 can be contained in a service tenancy 1319 that can be owned and/or operated by the IaaS provider.

The control plane VCN 1316 can include a control plane demilitarized zone (DMZ) tier 1320 that acts as a perimeter network (e.g., portions of a corporate network between the corporate intranet and external networks). The DMZ-based servers may have restricted responsibilities and help keep breaches contained. Additionally, the DMZ tier 1320 can include one or more load balancer (LB) subnet(s) 1322, a control plane app tier 1324 that can include app subnet(s) 1326, a control plane data tier 1328 that can include database (DB) subnet(s) 1330 (e.g., frontend DB subnet(s) and/or backend DB subnet(s)). The LB subnet(s) 1322 contained in the control plane DMZ tier 1320 can be communicatively coupled to the app subnet(s) 1326 contained in the control plane app tier 1324 and an Internet gateway 1334 that can be contained in the control plane VCN 1316, and the app subnet(s) 1326 can be communicatively coupled to the DB subnet(s) 1330 contained in the control plane data tier 1328 and a service gateway 1336 and a network address translation (NAT) gateway 1338. The control plane VCN 1316 can include the service gateway 1336 and the NAT gateway 1338.

The control plane VCN 1316 can include a data plane mirror app tier 1340 that can include app subnet(s) 1326. The app subnet(s) 1326 contained in the data plane mirror app tier 1340 can include a virtual network interface controller (VNIC) 1342 that can execute a compute instance 1344. The compute instance 1344 can communicatively couple the app subnet(s) 1326 of the data plane mirror app tier 1340 to app subnet(s) 1326 that can be contained in a data plane app tier 1346.

The data plane VCN 1318 can include the data plane app tier 1346, a data plane DMZ tier 1348, and a data plane data tier 1350. The data plane DMZ tier 1348 can include LB subnet(s) 1322 that can be communicatively coupled to the app subnet(s) 1326 of the data plane app tier 1346 and the Internet gateway 1334 of the data plane VCN 1318. The app subnet(s) 1326 can be communicatively coupled to the service gateway 1336 of the data plane VCN 1318 and the NAT gateway 1338 of the data plane VCN 1318. The data plane data tier 1350 can also include the DB subnet(s) 1330 that can be communicatively coupled to the app subnet(s) 1326 of the data plane app tier 1346.

The Internet gateway 1334 of the control plane VCN 1316 and of the data plane VCN 1318 can be communicatively coupled to a metadata management service 1352 that can be communicatively coupled to public Internet 1354. Public Internet 1354 can be communicatively coupled to the NAT gateway 1338 of the control plane VCN 1316 and of the data plane VCN 1318. The service gateway 1336 of the control plane VCN 1316 and of the data plane VCN 1318 can be communicatively coupled to cloud services 1356.

In some examples, the service gateway 1336 of the control plane VCN 1316 or of the data plane VCN 1318 can make application programming interface (API) calls to cloud services 1356 without going through public Internet 1354. The API calls to cloud services 1356 from the service gateway 1336 can be one-way: the service gateway 1336 can make API calls to cloud services 1356, and cloud services 1356 can send requested data to the service gateway 1336. But, cloud services 1356 may not initiate API calls to the service gateway 1336.

In some examples, the secure host tenancy 1304 can be directly connected to the service tenancy 1319, which may be otherwise isolated. The secure host subnet 1308 can communicate with the SSH subnet 1314 through an LPG 1310 that may enable two-way communication over an otherwise isolated system. Connecting the secure host subnet 1308 to the SSH subnet 1314 may give the secure host subnet 1308 access to other entities within the service tenancy 1319.

The control plane VCN 1316 may allow users of the service tenancy 1319 to set up or otherwise provision desired resources. Desired resources provisioned in the control plane VCN 1316 may be deployed or otherwise used in the data plane VCN 1318. In some examples, the control plane VCN 1316 can be isolated from the data plane VCN 1318, and the data plane mirror app tier 1340 of the control plane VCN 1316 can communicate with the data plane app tier 1346 of the data plane VCN 1318 via VNICs 1342 that can be contained in the data plane mirror app tier 1340 and the data plane app tier 1346.

In some examples, users of the system, or customers, can make requests, for example, create, read, update, or delete (CRUD) operations, through public Internet 1354 that can communicate the requests to the metadata management service 1352. The metadata management service 1352 can communicate the request to the control plane VCN 1316 through the Internet gateway 1334. The request can be received by the LB subnet(s) 1322 contained in the control plane DMZ tier 1320. The LB subnet(s) 1322 may determine that the request is valid, and in response to this determination, the LB subnet(s) 1322 can transmit the request to app subnet(s) 1326 contained in the control plane app tier 1324. If the request is validated and requires a call to public Internet 1354, the call to public Internet 1354 may be transmitted to the NAT gateway 1338, which can make the call to public Internet 1354. Metadata that may be desired to be stored by the request can be stored in the DB subnet(s) 1330.

In some examples, the data plane mirror app tier 1340 can facilitate direct communication between the control plane VCN 1316 and the data plane VCN 1318. For example, changes, updates, or other suitable modifications to the configuration may be desired to be applied to the resources contained in the data plane VCN 1318. Via a VNIC 1342, the control plane VCN 1316 can directly communicate with and can thereby execute the changes, updates, or other suitable modifications to configuration to resources contained in the data plane VCN 1318.

In some embodiments, the control plane VCN 1316 and the data plane VCN 1318 can be contained in the service tenancy 1319. In this case, the user or the customer of the system may not own or operate either the control plane VCN 1316 or the data plane VCN 1318. Instead, the IaaS provider may own or operate the control plane VCN 1316 and the data plane VCN 1318, both of which may be contained in the service tenancy 1319. This embodiment can enable the isolation of networks that may prevent users or customers from interacting with other users' or other customers' resources. Also, this embodiment may allow users or customers of the system to store databases privately without needing to rely on public Internet 1354, which may not have a desired level of threat prevention for storage.

In other embodiments, the LB subnet(s) 1322 contained in the control plane VCN 1316 can be configured to receive a signal from the service gateway 1336. In this embodiment, the control plane VCN 1316 and the data plane VCN 1318 may be configured to be called by a customer of the IaaS provider without calling public Internet 1354. Customers of the IaaS provider may desire this embodiment since the database(s) that the customers use may be controlled by the IaaS provider and may be stored on the service tenancy 1319, which may be isolated from public Internet 1354.

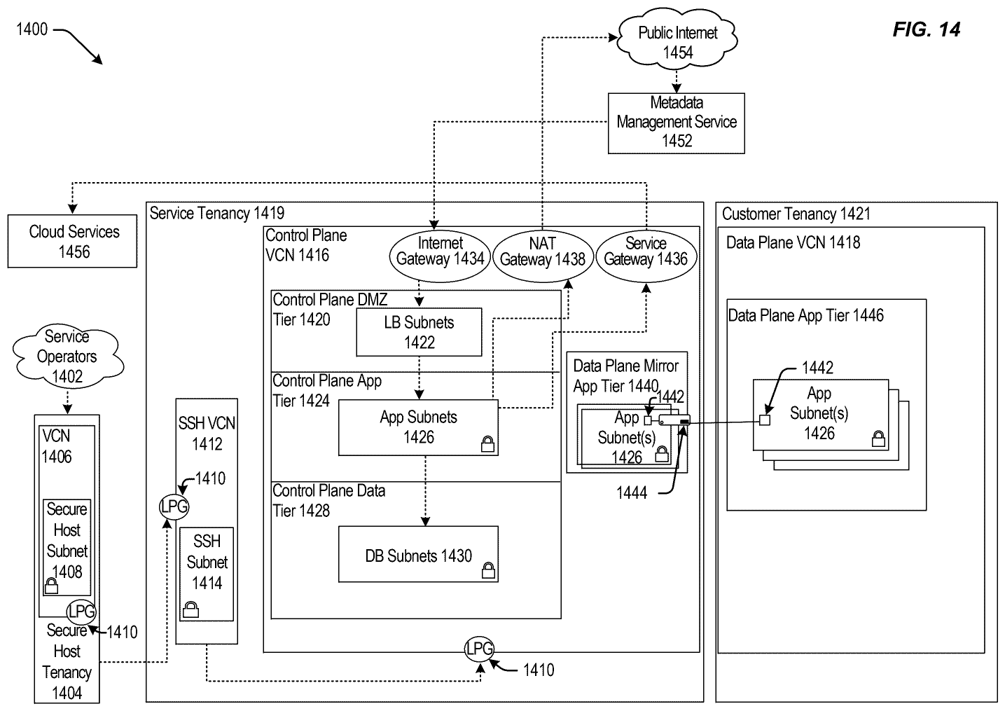

FIG. 14 is a block diagram 1400 illustrating another example pattern of an IaaS architecture, according to at least one embodiment. Service operators 1402 (e.g., service operators 1302 of FIG. 13) can be communicatively coupled to a secure host tenancy 1404 (e.g., the secure host tenancy 1304 of FIG. 13) that can include a virtual cloud network (VCN) 1406 (e.g., the VCN 1306 of FIG. 13) and a secure host subnet 1408 (e.g., the secure host subnet 1308 of FIG. 13). The VCN 1406 can include a local peering gateway (LPG) 1410 (e.g., the LPG 1310 of FIG. 13) that can be communicatively coupled to a secure shell (SSH) VCN 1412 (e.g., the SSH VCN 1312 of FIG. 13) via an LPG 1310 contained in the SSH VCN 1412. The SSH VCN 1412 can include an SSH subnet 1414 (e.g., the SSH subnet 1314 of FIG. 13), and the SSH VCN 1412 can be communicatively coupled to a control plane VCN 1416 (e.g., the control plane VCN 1316 of FIG. 13) via an LPG 1410 contained in the control plane VCN 1416. The control plane VCN 1416 can be contained in a service tenancy 1419 (e.g., the service tenancy 1319 of FIG. 13), and the data plane VCN 1418 (e.g., the data plane VCN 1318 of FIG. 13) can be contained in a customer tenancy 1421 that may be owned or operated by users, or customers, of the system.

The control plane VCN 1416 can include a control plane DMZ tier 1420 (e.g., the control plane DMZ tier 1320 of FIG. 13) that can include LB subnet(s) 1422 (e.g., LB subnet(s) 1322 of FIG. 13), a control plane app tier 1424 (e.g., the control plane app tier 1324 of FIG. 13) that can include app subnet(s) 1426 (e.g., app subnet(s) 1326 of FIG. 13), a control plane data tier 1428 (e.g., the control plane data tier 1328 of FIG. 13) that can include database (DB) subnet(s) 1430 (e.g., similar to DB subnet(s) 1330 of FIG. 13). The LB subnet(s) 1422 contained in the control plane DMZ tier 1420 can be communicatively coupled to the app subnet(s) 1426 contained in the control plane app tier 1424 and an Internet gateway 1434 (e.g., the Internet gateway 1334 of FIG. 13) that can be contained in the control plane VCN 1416, and the app subnet(s) 1426 can be communicatively coupled to the DB subnet(s) 1430 contained in the control plane data tier 1428 and a service gateway 1436 (e.g., the service gateway 1336 of FIG. 13) and a network address translation (NAT) gateway 1438 (e.g., the NAT gateway 1338 of FIG. 13). The control plane VCN 1416 can include the service gateway 1436 and the NAT gateway 1438.

The control plane VCN 1416 can include a data plane mirror app tier 1440 (e.g., the data plane mirror app tier 1340 of FIG. 13) that can include app subnet(s) 1426. The app subnet(s) 1426 contained in the data plane mirror app tier 1440 can include a virtual network interface controller (VNIC) 1442 (e.g., the VNIC of 1342) that can execute a compute instance 1444 (e.g., similar to the compute instance 1344 of FIG. 13). The compute instance 1444 can facilitate communication between the app subnet(s) 1426 of the data plane mirror app tier 1440 and the app subnet(s) 1426 that can be contained in a data plane app tier 1446 (e.g., the data plane app tier 1346 of FIG. 13) via the VNIC 1442 contained in the data plane mirror app tier 1440 and the VNIC 1442 contained in the data plane app tier 1446.

The Internet gateway 1434 contained in the control plane VCN 1416 can be communicatively coupled to a metadata management service 1452 (e.g., the metadata management service 1352 of FIG. 13) that can be communicatively coupled to public Internet 1454 (e.g., public Internet 1354 of FIG. 13). Public Internet 1454 can be communicatively coupled to the NAT gateway 1438 contained in the control plane VCN 1416. The service gateway 1436 contained in the control plane VCN 1416 can be communicatively coupled to cloud services 1456 (e.g., cloud services 1356 of FIG. 13).

In some examples, the data plane VCN 1418 can be contained in the customer tenancy 1421. In this case, the IaaS provider may provide the control plane VCN 1416 for each customer, and the IaaS provider may, for each customer, set up a unique compute instance 1444 that is contained in the service tenancy 1419. Each compute instance 1444 may allow communication between the control plane VCN 1416, contained in the service tenancy 1419, and the data plane VCN 1418, which is contained in the customer tenancy 1421. The compute instance 1444 may allow resources that are provisioned in the control plane VCN 1416, which is contained in the service tenancy 1419 to be deployed or otherwise used in the data plane VCN 1418, which is contained in the customer tenancy 1421.

In other examples, the customer of the IaaS provider may have databases that live in the customer tenancy 1421. In this example, the control plane VCN 1416 can include the data plane mirror app tier 1440, which can include app subnet(s) 1426. The data plane mirror app tier 1440 can reside in the data plane VCN 1418, but the data plane mirror app tier 1440 may not live in the data plane VCN 1418. That is, the data plane mirror app tier 1440 may have access to the customer tenancy 1421, but the data plane mirror app tier 1440 may not exist in the data plane VCN 1418 or be owned or operated by the customer of the IaaS provider. The data plane mirror app tier 1440 may be configured to make calls to the data plane VCN 1418 but may not be configured to make calls to any entity contained in the control plane VCN 1416. The customer may desire to deploy or otherwise use resources in the data plane VCN 1418 that are provisioned in the control plane VCN 1416, and the data plane mirror app tier 1440 can facilitate the desired deployment or other usage of resources of the customer.

In some embodiments, the customer of the IaaS provider can apply filters to the data plane VCN 1418. In this embodiment, the customer can determine what the data plane VCN 1418 can access, and the customer may restrict access to public Internet 1454 from the data plane VCN 1418. The IaaS provider may not be able to apply filters or otherwise control access of the data plane VCN 1418 to any outside networks or databases. Applying filters and controls by the customer onto the data plane VCN 1418, contained in the customer tenancy 1421, can help isolate the data plane VCN 1418 from other customers and from public Internet 1454.

In some embodiments, cloud services 1456 can be called by the service gateway 1436 to access services that may not exist on public Internet 1454, on the control plane VCN 1416, or on the data plane VCN 1418. The connection between cloud services 1456 and the control plane VCN 1416 or the data plane VCN 1418 may not be live or continuous. Cloud services 1456 may exist on a different network owned or operated by the IaaS provider. Cloud services 1456 may be configured to receive calls from the service gateway 1436 and may be configured to not receive calls from public Internet 1454. Some cloud services 1456 may be isolated from other cloud services 1456, and the control plane VCN 1416 may be isolated from cloud services 1456, which may not be in the same region as the control plane VCN 1416. For example, the control plane VCN 1416 may be located in “Region 1,” and cloud service “Deployment 13” may be located in Region 1 and in “Region 2.” If a call to Deployment 13 is made by the service gateway 1436 contained in the control plane VCN 1416 located in Region 1, the call may be transmitted to Deployment 13 in Region 1. In this example, the control plane VCN 1416, or Deployment 13 in Region 1, may not be communicatively coupled to, or otherwise in communication with, Deployment 13 in Region 2.

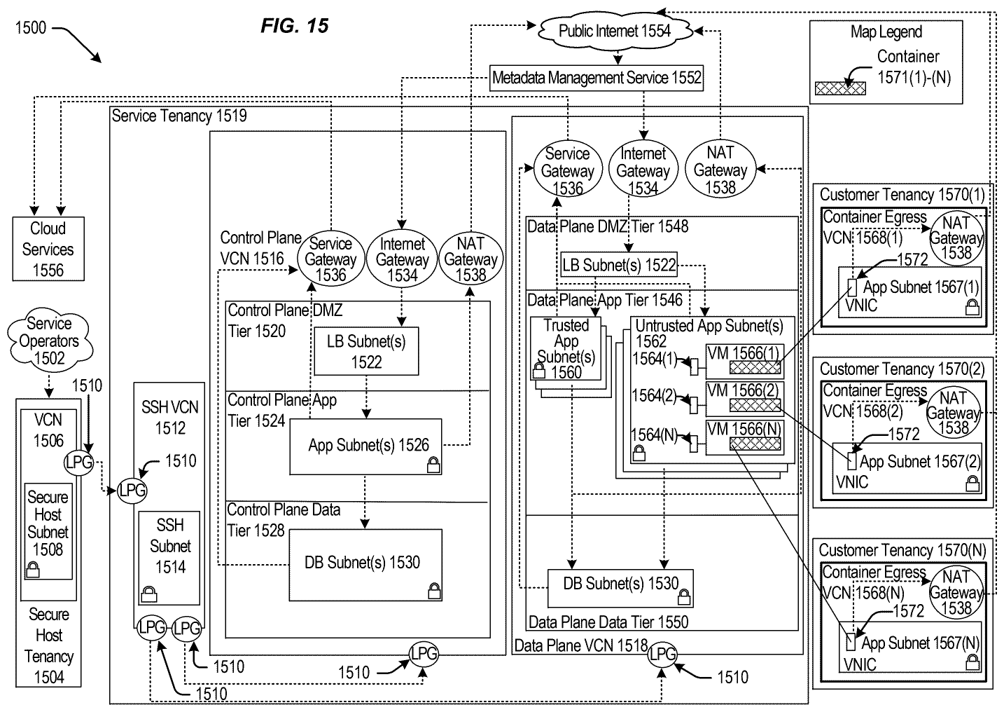

FIG. 15 is a block diagram 1500 illustrating another example pattern of an IaaS architecture, according to at least one embodiment. Service operators 1502 (e.g., service operators 1302 of FIG. 13) can be communicatively coupled to a secure host tenancy 1504 (e.g., the secure host tenancy 1304 of FIG. 13) that can include a virtual cloud network (VCN) 1506 (e.g., the VCN 1306 of FIG. 13) and a secure host subnet 1508 (e.g., the secure host subnet 1308 of FIG. 13). The VCN 1506 can include an LPG 1510 (e.g., the LPG 1310 of FIG. 13) that can be communicatively coupled to an SSH VCN 1512 (e.g., the SSH VCN 1312 of FIG. 13) via an LPG 1510 contained in the SSH VCN 1512. The SSH VCN 1512 can include an SSH subnet 1514 (e.g., the SSH subnet 1314 of FIG. 13), and the SSH VCN 1512 can be communicatively coupled to a control plane VCN 1516 (e.g., the control plane VCN 1316 of FIG. 13) via an LPG 1510 contained in the control plane VCN 1516 and to a data plane VCN 1518 (e.g., the data plane 1318 of FIG. 13) via an LPG 1510 contained in the data plane VCN 1518. The control plane VCN 1516 and the data plane VCN 1518 can be contained in a service tenancy 1519 (e.g., the service tenancy 1319 of FIG. 13).

The control plane VCN 1516 can include a control plane DMZ tier 1520 (e.g., the control plane DMZ tier 1320 of FIG. 13) that can include load balancer (LB) subnet(s) 1522 (e.g., LB subnet(s) 1322 of FIG. 13), a control plane app tier 1524 (e.g., the control plane app tier 1324 of FIG. 13) that can include app subnet(s) 1526 (e.g., similar to app subnet(s) 1326 of FIG. 13), a control plane data tier 1528 (e.g., the control plane data tier 1328 of FIG. 13) that can include DB subnet(s) 1530. The LB subnet(s) 1522 contained in the control plane DMZ tier 1520 can be communicatively coupled to the app subnet(s) 1526 contained in the control plane app tier 1524 and to an Internet gateway 1534 (e.g., the Internet gateway 1334 of FIG. 13) that can be contained in the control plane VCN 1516, and the app subnet(s) 1526 can be communicatively coupled to the DB subnet(s) 1530 contained in the control plane data tier 1528 and to a service gateway 1536 (e.g., the service gateway of FIG. 13) and a network address translation (NAT) gateway 1538 (e.g., the NAT gateway 1338 of FIG. 13). The control plane VCN 1516 can include the service gateway 1536 and the NAT gateway 1538.

The data plane VCN 1518 can include a data plane app tier 1546 (e.g., the data plane app tier 1346 of FIG. 13), a data plane DMZ tier 1548 (e.g., the data plane DMZ tier 1348 of FIG. 13), and a data plane data tier 1550 (e.g., the data plane data tier 1350 of FIG. 13). The data plane DMZ tier 1548 can include LB subnet(s) 1522 that can be communicatively coupled to trusted app subnet(s) 1560 and untrusted app subnet(s) 1562 of the data plane app tier 1546 and the Internet gateway 1534 contained in the data plane VCN 1518. The trusted app subnet(s) 1560 can be communicatively coupled to the service gateway 1536 contained in the data plane VCN 1518, the NAT gateway 1538 contained in the data plane VCN 1518, and DB subnet(s) 1530 contained in the data plane data tier 1550. The untrusted app subnet(s) 1562 can be communicatively coupled to the service gateway 1536 contained in the data plane VCN 1518 and DB subnet(s) 1530 contained in the data plane data tier 1550. The data plane data tier 1550 can include DB subnet(s) 1530 that can be communicatively coupled to the service gateway 1536 contained in the data plane VCN 1518.

The untrusted app subnet(s) 1562 can include one or more primary VNICs 1564(1)-(N) that can be communicatively coupled to tenant virtual machines (VMs) 1566(1)-(N). Each tenant VM 1566(1)-(N) can be communicatively coupled to a respective app subnet 1567(1)-(N) that can be contained in respective container egress VCNs 1568(1)-(N) that can be contained in respective customer tenancies 1570(1)-(N). Respective secondary VNICs 1572(1)-(N) can facilitate communication between the untrusted app subnet(s) 1562 contained in the data plane VCN 1518 and the app subnet contained in the container egress VCNs 1568(1)-(N). Each container egress VCNs 1568(1)-(N) can include a NAT gateway 1538 that can be communicatively coupled to public Internet 1554 (e.g., public Internet 1354 of FIG. 13).

The Internet gateway 1534 contained in the control plane VCN 1516 and contained in the data plane VCN 1518 can be communicatively coupled to a metadata management service 1552 (e.g., the metadata management system 1352 of FIG. 13) that can be communicatively coupled to public Internet 1554. Public Internet 1554 can be communicatively coupled to the NAT gateway 1538 contained in the control plane VCN 1516 and contained in the data plane VCN 1518. The service gateway 1536, contained in the control plane VCN 1516 and contained in the data plane VCN 1518, can be communicatively coupled to cloud services 1556.

In some embodiments, the data plane VCN 1518 can be integrated with customer tenancies 1570. This integration can be useful or desirable for customers of the IaaS provider in some cases, such as cases where customers may desire support when executing code. The customer may provide code to run that may be destructive, may communicate with other customer resources, or may otherwise cause undesirable effects. In response to this, the IaaS provider may determine whether to run the code given to the IaaS provider by the customer.

In some examples, the customer of the IaaS provider may grant temporary network access to the IaaS provider and request a function to be attached to the data plane app tier 1546. The code to run the function may be executed in VMs 1566(1)-(N), and the code may not be configured to run anywhere else on the data plane VCN 1518. Each VM 1566(1)-(N) may be connected to one customer tenancy 1570. Respective containers 1571(1)-(N) contained in the VMs 1566(1)-(N) may be configured to run the code. In this case, there can be dual isolation (e.g., the containers 1571(1)-(N) running code, where the containers 1571(1)-(N) may be contained in at least the VM 1566(1)-(N) that are contained in the untrusted app subnet(s) 1562), which may help prevent incorrect or otherwise undesirable code from damaging the network of the IaaS provider or from damaging a network of a different customer. The containers 1571(1)-(N) may be communicatively coupled to the customer tenancy 1570 and may be configured to transmit or receive data from the customer tenancy 1570. The containers 1571(1)-(N) may not be configured to transmit or receive data from any other entity in the data plane VCN 1518. Upon completion of running the code, the IaaS provider may kill or otherwise dispose of the containers 1571(1)-(N).

In some embodiments, the trusted app subnet(s) 1560 may run code that may be owned or operated by the IaaS provider. In this embodiment, the trusted app subnet(s) 1560 may be communicatively coupled to the DB subnet(s) 1530 and be configured to execute CRUD operations in the DB subnet(s) 1530. The untrusted app subnet(s) 1562 may be communicatively coupled to the DB subnet(s) 1530, but in this embodiment, the untrusted app subnet(s) may be configured to execute read operations in the DB subnet(s) 1530. The containers 1571(1)-(N) that can be contained in the VM 1566(1)-(N) of each customer and that may run code from the customer may not be communicatively coupled with the DB subnet(s) 1530.

In other embodiments, the control plane VCN 1516 and the data plane VCN 1518 may not be directly communicatively coupled. In this embodiment, there may be no direct communication between the control plane VCN 1516 and the data plane VCN 1518. However, communication can occur indirectly through at least one method. An LPG 1510 may be established by the IaaS provider to facilitate communication between the control plane VCN 1516 and the data plane VCN 1518. In another example, the control plane VCN 1516 or the data plane VCN 1518 can make a call to cloud services 1556 via the service gateway 1536. For example, a call to cloud services 1556 from the control plane VCN 1516 can include a request for a service that can communicate with the data plane VCN 1518.

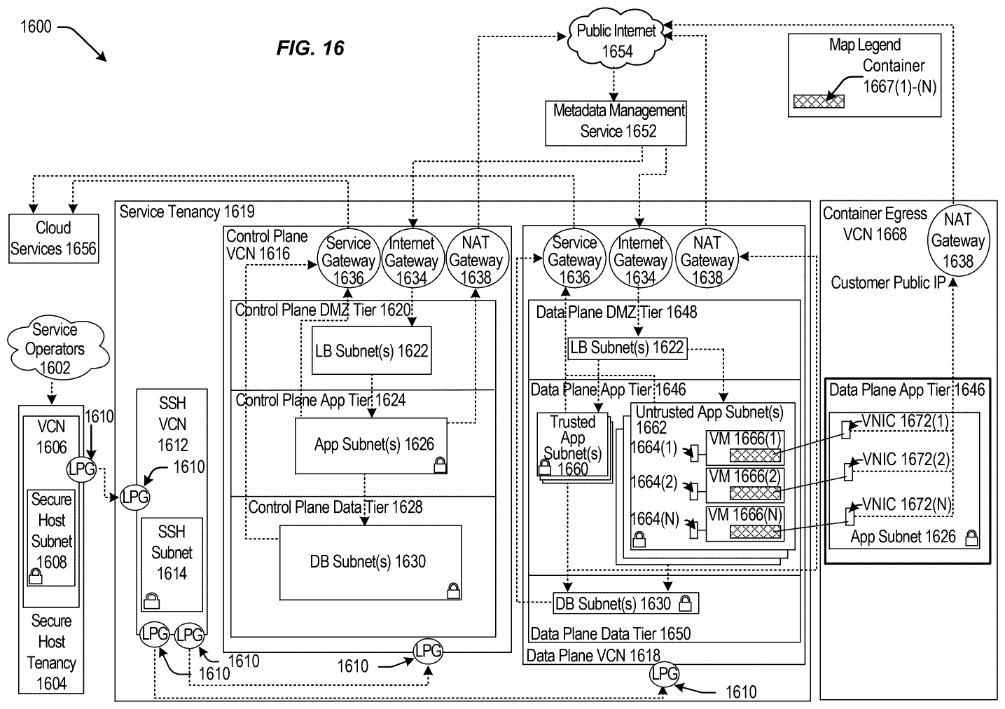

FIG. 16 is a block diagram 1600 illustrating another example pattern of an IaaS architecture, according to at least one embodiment. Service operators 1602 (e.g., service operators 1302 of FIG. 13) can be communicatively coupled to a secure host tenancy 1604 (e.g., the secure host tenancy 1304 of FIG. 13) that can include a virtual cloud network (VCN) 1606 (e.g., the VCN 1306 of FIG. 13) and a secure host subnet 1608 (e.g., the secure host subnet 1308 of FIG. 13). The VCN 1606 can include an LPG 1610 (e.g., the LPG 1310 of FIG. 13) that can be communicatively coupled to an SSH VCN 1612 (e.g., the SSH VCN 1312 of FIG. 13) via an LPG 1610 contained in the SSH VCN 1612. The SSH VCN 1612 can include an SSH subnet 1614 (e.g., the SSH subnet 1314 of FIG. 13), and the SSH VCN 1612 can be communicatively coupled to a control plane VCN 1616 (e.g., the control plane VCN 1316 of FIG. 13) via an LPG 1610 contained in the control plane VCN 1616 and to a data plane VCN 1618 (e.g., the data plane 1318 of FIG. 13) via an LPG 1610 contained in the data plane VCN 1618. The control plane VCN 1616 and the data plane VCN 1618 can be contained in a service tenancy 1619 (e.g., the service tenancy 1319 of FIG. 13).

The control plane VCN 1616 can include a control plane DMZ tier 1620 (e.g., the control plane DMZ tier 1320 of FIG. 13) that can include LB subnet(s) 1622 (e.g., LB subnet(s) 1322 of FIG. 13), a control plane app tier 1624 (e.g., the control plane app tier 1324 of FIG. 13) that can include app subnet(s) 1626 (e.g., app subnet(s) 1326 of FIG. 13), a control plane data tier 1628 (e.g., the control plane data tier 1328 of FIG. 13) that can include DB subnet(s) 1630 (e.g., DB subnet(s) 1530 of FIG. 15). The LB subnet(s) 1622 contained in the control plane DMZ tier 1620 can be communicatively coupled to the app subnet(s) 1626 contained in the control plane app tier 1624 and to an Internet gateway 1634 (e.g., the Internet gateway 1334 of FIG. 13) that can be contained in the control plane VCN 1616, and the app subnet(s) 1626 can be communicatively coupled to the DB subnet(s) 1630 contained in the control plane data tier 1628 and to a service gateway 1636 (e.g., the service gateway of FIG. 13) and a network address translation (NAT) gateway 1638 (e.g., the NAT gateway 1338 of FIG. 13). The control plane VCN 1616 can include the service gateway 1636 and the NAT gateway 1638.

The data plane VCN 1618 can include a data plane app tier 1646 (e.g., the data plane app tier 1346 of FIG. 13), a data plane DMZ tier 1648 (e.g., the data plane DMZ tier 1348 of FIG. 13), and a data plane data tier 1650 (e.g., the data plane data tier 1350 of FIG. 13). The data plane DMZ tier 1648 can include LB subnet(s) 1622 that can be communicatively coupled to trusted app subnet(s) 1660 (e.g., trusted app subnet(s) 1560 of FIG. 15) and untrusted app subnet(s) 1662 (e.g., untrusted app subnet(s) 1562 of FIG. 15) of the data plane app tier 1646 and the Internet gateway 1634 contained in the data plane VCN 1618. The trusted app subnet(s) 1660 can be communicatively coupled to the service gateway 1636 contained in the data plane VCN 1618, the NAT gateway 1638 contained in the data plane VCN 1618, and DB subnet(s) 1630 contained in the data plane data tier 1650. The untrusted app subnet(s) 1662 can be communicatively coupled to the service gateway 1636 contained in the data plane VCN 1618 and DB subnet(s) 1630 contained in the data plane data tier 1650. The data plane data tier 1650 can include DB subnet(s) 1630 that can be communicatively coupled to the service gateway 1636 contained in the data plane VCN 1618.

The untrusted app subnet(s) 1662 can include primary VNICs 1664(1)-(N) that can be communicatively coupled to tenant virtual machines (VMs) 1666(1)-(N) residing within the untrusted app subnet(s) 1662. Each tenant VM 1666(1)-(N) can run code in a respective container 1667(1)-(N) and be communicatively coupled to an app subnet 1626 that can be contained in a data plane app tier 1646 that can be contained in a container egress VCN 1668. Respective secondary VNICs 1672(1)-(N) can facilitate communication between the untrusted app subnet(s) 1662 contained in the data plane VCN 1618 and the app subnet contained in the container egress VCN 1668. The container egress VCN can include a NAT gateway 1638 that can be communicatively coupled to public Internet 1654 (e.g., public Internet 1354 of FIG. 13).

The Internet gateway 1634 contained in the control plane VCN 1616 and contained in the data plane VCN 1618 can be communicatively coupled to a metadata management service 1652 (e.g., the metadata management system 1352 of FIG. 13) that can be communicatively coupled to public Internet 1654. Public Internet 1654 can be communicatively coupled to the NAT gateway 1638 contained in the control plane VCN 1616 and contained in the data plane VCN 1618. The service gateway 1636 contained in the control plane VCN 1616 and contained in the data plane VCN 1618 can be communicatively coupled to cloud services 1656.

In some examples, the pattern is illustrated by the architecture of block diagram 1600 of FIG. 16 may be considered an exception to the pattern illustrated by the architecture of block diagram 1500 of FIG. 15 and may be desirable for a customer of the IaaS provider if the IaaS provider cannot directly communicate with the customer (e.g., a disconnected region). The respective containers 1667(1)-(N) that are contained in the VMs 1666(1)-(N) for each customer can be accessed in real-time by the customer. The containers 1667(1)-(N) may be configured to make calls to respective secondary VNICs 1672(1)-(N) contained in app subnet(s) 1626 of the data plane app tier 1646 that can be contained in the container egress VCN 1668. The secondary VNICs 1672(1)-(N) can transmit the calls to the NAT gateway 1638, which may transmit the calls to public Internet 1654. In this example, the containers 1667(1)-(N) that can be accessed in real-time by the customer can be isolated from the control plane VCN 1616 and can be isolated from other entities contained in the data plane VCN 1618. The containers 1667(1)-(N) may also be isolated from resources from other customers.

In other examples, the customer can use the containers 1667(1)-(N) to call cloud services 1656. In this example, the customer may run code in the containers 1667(1)-(N) that requests a service from cloud services 1656. The containers 1667(1)-(N) can transmit this request to the secondary VNICs 1672(1)-(N) which can transmit the request to the NAT gateway that can transmit the request to public Internet 1654. Public Internet 1654 can transmit the request to LB subnet(s) 1622 contained in the control plane VCN 1616 via the Internet gateway 1634. In response to determining whether the request is valid, the LB subnet(s) can transmit the request to app subnet(s) 1626, which can transmit the request to cloud services 1656 via the service gateway 1636.

It should be appreciated that IaaS architectures 1300, 1400, 1500, and 1600 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assigned.

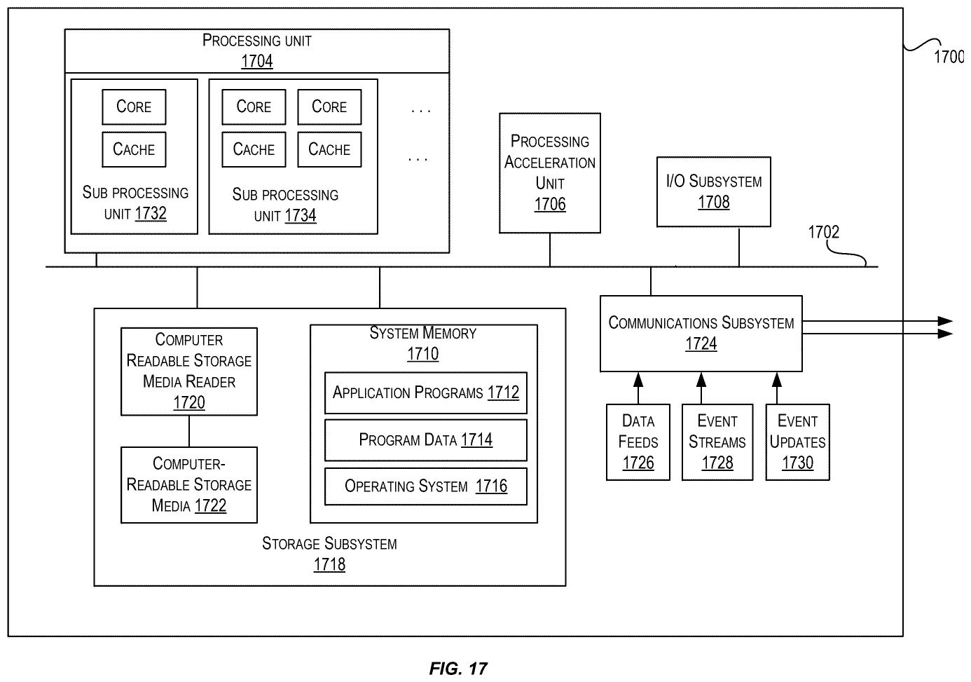

FIG. 17 illustrates an example computer system 1700, in which various embodiments may be implemented. The system 1700 may be used to implement any of the computer systems described above. As shown in the figure, computer system 1700 includes a processing unit 1704 that communicates with a number of peripheral subsystems via a bus subsystem 1702. These peripheral subsystems may include a processing acceleration unit 1706, an I/O subsystem 1708, a storage subsystem 1718, and a communications subsystem 1724. Storage subsystem 1718 includes tangible computer-readable storage media 1722 and a system memory 1710.

Bus subsystem 1702 provides a mechanism for letting the various components and subsystems of computer system 1700 communicate with each other as intended. Although bus subsystem 1702 is shown schematically as a single bus, alternative embodiments of the bus subsystem may utilize multiple buses. Bus subsystem 1702 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1704, which can be implemented as one or more integrated circuits (e.g., a conventional microprocessor or microcontroller), controls the operation of computer system 1700. One or more processors may be included in processing unit 1704. These processors may include single-core or multicore processors. In certain embodiments, processing unit 1704 may be implemented as one or more independent processing units 1732 and/or 1734, with single or multicore processors included in each processing unit. In other embodiments, processing unit 1704 may also be implemented as a quad-core processing unit formed by integrating two dual-core processors into a single chip.

In various embodiments, processing unit 1704 can execute a variety of programs in response to program code and can maintain multiple concurrently executing programs or processes. At any given time, some or all of the program code to be executed can be resident in processor(s) 1704 and/or in storage subsystem 1718. Through suitable programming, processor(s) 1704 can provide various functionalities described above. Computer system 1700 may additionally include a processing acceleration unit 1706, which can include a digital signal processor (DSP), a special-purpose processor, and/or the like.

I/O subsystem 1708 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator) through voice commands.

User interface input devices may also include, without limitation, three-dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

User interface output devices may include a display subsystem, indicator lights, or non-visual displays such as audio output devices etc. The display subsystem may be a cathode ray tube (CRT), a flat-panel device, such as that using a liquid crystal display (LCD) or plasma display, a projection device, a touch screen, and the like. In general, the use of the term “output device” is intended to include all possible types of devices and mechanisms for outputting information from computer system 1700 to a user or other computer. For example, user interface output devices may include, without limitation, a variety of display devices that visually convey text, graphics, and audio/video information, such as monitors, printers, speakers, headphones, automotive navigation systems, plotters, voice output devices, and modems.

Computer system 1700 may comprise a storage subsystem 1718 that provides a tangible, non-transitory computer-readable storage medium for storing software and data constructs that provide the functionality of the embodiments described in this disclosure. The software can include programs, code modules, instructions, scripts, etc., that, when executed by one or more cores or processors of processing unit 1704, provide the functionality described above. Storage subsystem 1718 may also provide a repository for storing data used in accordance with the present disclosure.

As depicted in the example in FIG. 17, storage subsystem 1718 can include various components, including system memory 1710, computer-readable storage media 1722, and a computer-readable storage media reader 1720. System memory 1710 may store program instructions of application programs 1712 that are loadable and executable by processing unit 1704. System memory 1710 may store program data 1714 that is used during the execution of the instructions and/or data that is generated during the execution of the program instructions. Various different kinds of programs may be loaded into system memory 1710, including but not limited to client applications, Web browsers, mid-tier applications, relational database management systems (RDBMS), virtual machines, containers, etc.

System memory 1710 may also store an operating system 1716. Examples of operating system 1716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1700 executes one or more virtual machines, the virtual machines, along with their guest operating systems (GOSs), may be loaded into system memory 1710 and executed by one or more processors or cores of processing unit 1704.

System memory 1710 can come in different configurations depending upon the type of computer system 1700. For example, system memory 1710 may be volatile memory (such as random access memory (RAM)) and/or non-volatile memory (such as read-only memory (ROM), flash memory, etc.) Different types of RAM configurations may be provided, including a static random access memory (SRAM), a dynamic random access memory (DRAM), and others. In some implementations, system memory 1710 may include a basic input/output system (BIOS) containing basic routines that help to transfer information between elements within computer system 1700, such as during start-up.

Computer-readable storage media 1722 may represent remote, local, fixed, and/or removable storage devices plus storage media for temporarily and/or more permanently containing, storing, computer-readable information for use by computer system 1700, including instructions executable by processing unit 1704 of computer system 1700.

Computer-readable storage media 1722 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM

(EEPROM), flash memory or other memory technology, CD-ROM, digital versatile disk (DVD), or other optical storage, magnetic cassettes, magnetic tape, magnetic disk storage or other magnetic storage devices, or other tangible computer-readable media.

By way of example, computer-readable storage media 1722 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1722 may include but is not limited to, Zip® drives, flash memory cards, universal serial bus (USB) flash drives, secure digital (SD) cards, DVD disks, digital video tape, and the like. Computer-readable storage media 1722 may also include solid-state drives (SSD) based on non-volatile memory such as flash-memory-based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1700.

Machine-readable instructions executable by one or more processors or cores of processing unit 1704 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1724 provides an interface to other computer systems and networks. Communications subsystem 1724 serves as an interface for receiving data from and transmitting data to other systems from computer system 1700. For example, communications subsystem 1724 may enable computer system 1700 to connect to one or more devices via the Internet. In some embodiments communications subsystem 1724 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments, communications subsystem 1724 can provide wired network connectivity (e.g., Ethernet) in addition to or instead of a wireless interface.

In some embodiments, communications subsystem 1724 may also receive input communication in the form of structured and/or unstructured data feeds 1726, event streams 1728, event updates 1730, and the like on behalf of one or more users who may use computer system 1700.

By way of example, communications subsystem 1724 may be configured to receive data feeds 1726 in real-time from users of social networks and/or other communication services such as Twitter® feeds, Facebook® updates, web feeds such as Rich Site Summary (RSS) feeds, and/or real-time updates from one or more third-party information sources.

Additionally, communications subsystem 1724 may also be configured to receive data in the form of continuous data streams, which may include event streams 1728 of real-time events and/or event updates 1730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1724 may also be configured to output the structured and/or unstructured data feeds 1726, event streams 1728, event updates 1730, and the like to one or more databases that may be in communication with one or more streaming data source computers coupled to computer system 1700.

Computer system 1700 can be one of various types, including a handheld portable device (e.g., an iPhone® cellular phone, an iPad® computing tablet, a PDA), a wearable device (e.g., a Google Glass® head-mounted display), a PC, a workstation, a mainframe, a kiosk, a server rack, or any other data processing system.

Due to the ever-changing nature of computers and networks, the description of computer system 1700 depicted in the figure is intended only as a specific example. Many other configurations having more or fewer components than the system depicted in the figure are possible. For example, customized hardware might also be used, and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation or any combination thereof. Processes can communicate using a variety of techniques, including but not limited to conventional techniques for inter-process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein is merely intended to serve as a shorthand method of referring individually to each separate value falling within the range unless otherwise indicated herein, and each separate value is incorporated into the specification as if it were individually recited herein. All methods described herein can be performed in any suitable order unless otherwise indicated herein or otherwise clearly contradicted by context. The use of any and all examples or exemplary language (e.g., “such as”) provided herein is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate, and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
identifying a set of one or more hypervisors for outage simulation, wherein a set of one or more computing devices respectively host the set of one or more hypervisors;
identifying a set of one or more integrated managers respectively corresponding to the set of one or more computing devices hosting the set of one or more hypervisors;
simulating an outage based at least in part on executing, by each of the set of one or more integrated managers, a first set of one or more operations associated with powering down the set of one or more computing devices;
simulating a restoration based at least in part on executing, by each of the set of one or more integrated managers, a second set of one or more operations associated with powering up the set of one or more computing devices; and
monitoring and transmitting recovery metrics respectively associated with recovery of the set of one or more hypervisors responsive to stimulating the restoration.

2. The computer-implemented method of claim 1, wherein the set of one or more integrated managers respectively comprise a set of processors, wherein the set of processors are respectively embedded in the set of one or more computing devices, and wherein the set of processors are configured to provide management interfaces respectively for the set of one or more computing devices.

3. The computer-implemented method of claim 2, wherein firmware on the set of processors are respectively configured to operate responsive to applying power to the set of one or more computing devices, regardless of whether the set of one or more computing devices have been powered on.

4. The computer-implemented method of claim 1, wherein executing the first set of one or more operations associated with powering down the set of one or more computing devices causes shutdowns of the set of one or more computing devices that close at least one of applications or files, respectively opened on the set of one or more computing devices, without saving changes.

5. The computer-implemented method of claim 1, further comprising at least one of:
presenting at least one of the recovery metrics at a user interface; and
transmitting information indicating a result of a comparison between at least a recovery metric of the recovery metrics and at least one of a predefined threshold or a historically derived value for the recovery metric.

6. The computer-implemented method of claim 1, wherein the recovery of the set of one or more hypervisors is determined based on confirming that connections to the set of one or more computing devices have been established subsequent to stimulating the restoration.

7. The computer-implemented method of claim 1, wherein simulating the outage comprises transmitting a first set of one or more instructions to the set of one or more integrated managers to power down the set of one or more computing devices, and wherein simulating the restoration comprises transmitting a second set of one or more instructions to set of integrated managers to power up the set of one or more computing devices.

8. The computer-implemented method of claim 1, wherein monitoring the recovery metrics comprises:
periodically attempting to establish connections to the set of one or more computing devices; and
measuring a duration between (a) a first time associated with simulating the restoration and (b) a second time associated with successfully establishing the connections to the set of one or more computing devices.

9. The computer-implemented method of claim 1, wherein the set of one or more hypervisors are selected from a plurality of hypervisors for the outage simulation based at least in part on a command provided as input to a command line interface, the command referencing a configuration file that identifies the set of one or more hypervisors.

10. A computer-implemented method, comprising:
identifying a set of one or more hypervisors for fault simulation, wherein a set of one or more computing devices respectively host the set of one or more hypervisors, and the set of one or more hypervisors are respectively associated with a set of boot volumes;
identifying a set of one or more network interface cards respectively corresponding to the set of one or more computing devices hosting the set of one or more hypervisors;
simulating a fault based at least in part on executing, by each of the set of one or more network interface cards, a first set of one or more operations associated with detaching the set of boot volumes respectively from the set of one or more hypervisors;
simulating a restoration based at least in part on executing, by each of the network interface cards, a second set of one or more operations associated with re-attaching the set of boot volumes respectively to the set of one or more hypervisors; and
monitoring and transmitting recovery metrics respectively associated with recovery of the set of one or more hypervisors responsive to stimulating the restoration.

11. The computer-implemented method of claim 10, wherein the set of one or more network interface cards respectively comprise a set of processors, and the set of processors are respectively embedded in the set of one or more network interface cards, and the set of processors are configured to provide management interfaces respectively for the set of one or more network interface cards.

12. The computer-implemented method of claim 10, wherein executing the first set of one or more operations associated with detaching the set of boot volumes respectively from the set of one or more hypervisors causes a corresponding set of integrated managers of the set of one or more computing devices to power down the set of one or more computing devices, wherein powering down the set of one or more computing devices closes at least one of applications or files, respectively opened on the set of one or more computing devices, without saving changes.

13. The computer-implemented method of claim 12, wherein the set of one or more integrated managers respectively comprise a set of processors, wherein the set of processors are respectively embedded in the set of one or more integrated managers, wherein the set of processors are configured to provide management interfaces respectively for the set of one or more computing devices, and wherein firmware on the set of processors are respectively configured to operate responsive to applying power to the set of one or more computing devices, regardless of whether the set of one or more computing devices have been powered on.

14. The computer-implemented method of claim 10, further comprising initializing one or more validation processes that are configured to periodically attempt establishing connections to the set of one or more computing devices, wherein the one or more validation processes are initialized based at least in part on detecting that respective connections to the network interface cards have been established.

15. The computer-implemented method of claim 10, wherein executing the first set of one or more operations associated with detaching the set of boot volumes respectively from the set of one or more hypervisors causes respective watchdog daemons executing at each of the set of one or more computing devices to:
transmit one or more write requests to a corresponding boot volume;
detect, based on the one or more write requests, that the corresponding boot volume is in a read-only mode; and
initiate a reboot of a corresponding hypervisor, causing the corresponding hypervisor to enter a wait-for-recovery mode to wait for recovery of a boot volume dependency.

16. A simulation system, comprising:
one or more processors; and
one or more memories storing computer-executable instructions that, when executed by the one or more processors, cause the one or more processors to:
identify a set of one or more hypervisors, wherein a set of one or more computing devices respectively host the set of one or more hypervisors;
identifying a set of one or more computing components respectively corresponding to the set of one or more computing devices hosting the set of one or more hypervisors;
simulate a large-scale event based at least in part on executing, by each of the set of one or more computing components, a first set of one or more operations;
simulate a restoration based at least in part on executing, by each of the set of one or more computing components, a second set of one or more operations; and
monitor and transmit recovery metrics respectively associated with recovery of the set of one or more hypervisors responsive to stimulating the restoration.

17. The simulation system of claim 16, wherein the large-scale event is a power outage or a block storage outage.

18. The simulation system of claim 16, wherein executing the computer-executable instructions further causes the one or more processors to perform at least one of:
generating one or more graphical representations depicting aspects of the recovery of the set of one or more hypervisors or corresponding to a set of virtual machines respectively managed by the set of one or more hypervisors; and
transmitting at least one of the recovery metrics to one or more logging services.

19. The simulation system of claim 16, wherein the set of one or more computing components comprise an integrated manager when the large-scale event is associated with a first event type, and wherein the set of one or more computing components comprise network interface cards when the large-scale event is associated with a second event type.

20. The simulation system of claim 16, wherein the first set of one or more operations are associated with powering down a corresponding computing device when the large-scale event is associated with a first event type, and wherein the first set of one or more operations are associated with detaching a network connection when the large-scale event is associated with a second event type.
